(19) United States
(12) Patent Application Publication
(10) Pub. No.: US 2023/0134535 A1
(43) Pub. Date: May 4, 2023

(54) INFORMATION PROCESSING APPARATUS, INFORMATION PROCESSING METHOD, AND INFORMATION PROCESSING PROGRAM

(71) Applicant: Nippon Telegraph and Telephone Corporation, Tokyo (JP)

(72) Inventors: Kenzo OKUDA, Musashino-shi, Tokyo (JP); Hitoshi MASUTANI, Musashino-shi, Tokyo (JP); Takeshi HIROTA, Musashino-shi, Tokyo (JP); Takeshi KUWAHARA, Musashino-shi, Tokyo (JP)

(21) Appl. No.: 17/915,410

(22) PCT Filed: Apr. 16, 2020
(86) PCT No.: PCT/JP2020/016690

§ 371 Date: Sep. 28, 2022

(51) Int. Cl. G06F 9/50; G06T 1/20; G06F 9/455

(52) U.S. Cl. CPC G06F 9/5038; G06T 1/20; G06F 9/455

(57) ABSTRACT

In an information processing device 100 including a GPU learning cluster, the GPU learning cluster includes a main container (first execution unit) 4 that executes a learning program of a job submitted by a user inside the job; and a helper container (second execution unit) 6 that executes processing of making a private network connection to a storage of the user to mount the storage inside the job. The main container (first execution unit) 4 reads data to be learned from the mounted storage, and executes the learning program by using the data to be learned.

### TECHNICAL FIELD

The present invention relates to an information processing device, an information processing method, and an information processing program.

### BACKGROUND ART

As a conventional technique, there is known a GPU learning cluster. The GPU learning cluster is a software program that executes a learning program of a job by using a GPU (Graphics Processing Unit), and operates on an information processing device such as a server device.

A cluster provider provides a user with an information processing device that performs learning processing by using a GPU learning cluster on behalf of the user. The user executes the job specifying the learning program on the information processing device, and acquires a learning processing result which is the resultant output. Since learning processing such as machine learning only needs to be executed once, the user only has to pay the cluster provider a weight charge according to the usage time of the information processing device, so that it does not require the user to own or purchase an expensive GPU and thus low cost.

On the other hand, for the cluster provider, it is the most important factor in improving profits to increase the GPU learning cluster availability. Therefore, for example, it is required to be able to execute various types of jobs in a GPU learning cluster and to speed up the deployment of jobs. Specifically, the execution environment for a job is implemented by a VM (Virtual Machine) or a container.

### CITATION LIST

### Non Patent Literature

[NPL 1]“Cluster Technology (Kubernetes)”, [retrieved on Mar. 18, 2020], Internet <URL: https://github.com/kubernetes/kubernetes>
[NPL 2]“Cluster Technology (Kubernetes)”, [retrieved on Mar. 18, 2020], Internet <URL: https://kubernetes.io/docs/concepts/overview/what-is-kubernetes/>

### SUMMARY OF THE INVENTION

### Technical Problem

An operation of the above-mentioned information processing device will be outlined.

A user transmits a job for a learning program to the GPU learning cluster of the information processing device, and stores data to be learned in a storage of the information processing device. The job uses a GPU resource attached to itself to perform learning processing while reading the data to be learned from the storage, and stores the learning processing result in the storage. After that, the user accesses that storage to acquire the learning processing result.

However, the data to be learned may be taken out from the user's site because the data to be learned is very large size or because of corporate rules, such as prevention of leakage of data to be learned, and requests for legal compliance. Therefore, for such a case, it is conceivable to provide a method of connecting the execution environment for the job to the user's storage over a private network.

However, since OSS (Open Source Software), which builds a GPU learning cluster, supports only frequently used communications such as HTTP (Hyper Text Transfer Protocol), it is difficult to implement such a private network connection. Further, even at the user site, it is difficult to always wait for a private network connection from the outside in consideration of security rules.

The present invention has been made in view of the above circumstances, and an object of the present invention is to provide a technique that can implement a private network connection to a storage of a user without making any changes to the virtual environment for a job for executing a learning program of the user and without modifying the core functions of OSS.

### Means for Solving the Problem

An information processing device according to one aspect of the present invention includes a GPU learning cluster, wherein the GPU learning cluster includes a first execution unit that executes a learning program of a job submitted by a user inside the job; and a second execution unit that executes processing of making a private network connection to a storage of the user to mount the storage inside the job, and the first execution unit reads data to be learned from the mounted storage, and executes the learning program by using the data to be learned.

An information processing method according to one aspect of the present invention is performed by an information processing device including a GPU learning cluster, the information processing method including a first step of executing, by the GPU learning cluster, a learning program of a job submitted by a user inside the job; and a second step of executing, by the GPU learning cluster, processing of making a private network connection to a storage of the user to mount the storage inside the job, wherein the first step includes reading data to be learned from the mounted storage, and executing the learning program by using the data to be learned.

An information processing program according to one aspect of the present invention causes an information processing device including a GPU learning cluster to execute: a first step of executing, by the GPU learning cluster, a learning program of a job submitted by a user inside the job; and a second step of executing, by the GPU learning cluster, processing of a private network connection to a storage of the user to mount the storage inside the job, wherein the first step includes reading data to be learned from the mounted storage, and executing the learning program by using the data to be learned.

### Effects of the Invention

According to the present invention, it is possible to provide a technique that can implement a private network connection to a storage of a user without making any changes to the virtual environment for a job for executing a learning program of the user and without modifying the core functions of OSS.

### BRIEF DESCRIPTION OF DRAWINGS

FIG. 1 is a diagram illustrating a basic configuration of an information processing device.

FIG. 2 is a diagram illustrating a basic operation sequence of the information processing device.

FIG. 3 is a diagram illustrating an improved configuration of the information processing device.

FIG. 4 is a diagram illustrating a problem with the improved configuration of the information processing device.

FIG. 5 is a diagram illustrating another improved configuration of the information processing device.

FIG. 6 is a diagram illustrating an image of a namespace.

FIG. 7 is a diagram illustrating a first job configuration pattern.

FIG. 8A is a diagram illustrating an operation sequence of the first job configuration pattern.

FIG. 8B is a diagram illustrating the operation sequence of the first job configuration pattern.

FIG. 8C is a diagram illustrating the operation sequence of the first job configuration pattern.

FIG. 9 is a diagram illustrating a second job configuration pattern.

FIG. 10A is a diagram illustrating an operation sequence of the second job configuration pattern.

FIG. 10B is a diagram illustrating the operation sequence of the second job configuration pattern.

FIG. 10C is a diagram illustrating the operation sequence of the second job configuration pattern.

FIG. 11 is a diagram illustrating a third job configuration pattern.

FIG. 12A is a diagram illustrating an operation sequence of the third job configuration pattern.

FIG. 12B is a diagram illustrating the operation sequence of the third job configuration pattern.

FIG. 12C is a diagram illustrating the operation sequence of the third job configuration pattern.

FIG. 13 is a diagram illustrating a fourth job configuration pattern.

FIG. 14A is a diagram illustrating an operation sequence of the fourth job configuration pattern.

FIG. 14B is a diagram illustrating the operation sequence of the fourth job configuration pattern.

FIG. 14C is a diagram illustrating the operation sequence of the fourth job configuration pattern.

FIG. 15 is a diagram illustrating a fifth job configuration pattern.

FIG. 16A is a diagram illustrating an operation sequence of the fifth job configuration pattern.

FIG. 16B is a diagram illustrating the operation sequence of the fifth job configuration pattern.

FIG. 16C is a diagram illustrating the operation sequence of the fifth job configuration pattern.

FIG. 17 is a diagram illustrating a sixth job configuration pattern.

FIG. 18A is a diagram illustrating an operation sequence of the sixth job configuration pattern.

FIG. 18B is a diagram illustrating the operation sequence of the sixth job configuration pattern.

FIG. 18C is a diagram illustrating the operation sequence of the sixth job configuration pattern.

FIG. 19 is a diagram illustrating a first private network connection method.

FIG. 20A is a diagram illustrating an operation sequence of the first private network connection method.

FIG. 20B is a diagram illustrating the operation sequence of the first private network connection method.

FIG. 20C is a diagram illustrating the operation sequence of the first private network connection method.

FIG. 21 is a diagram illustrating a second private network connection method.

FIG. 22A is a diagram illustrating an operation sequence of the second private network connection method (first method).

FIG. 22B is a diagram illustrating the operation sequence of the second private network connection method (first method).

FIG. 22C is a diagram illustrating the operation sequence of the second private network connection method (first method).

FIG. 22D is a diagram illustrating the operation sequence of the second private network connection method (first method).

FIG. 23A is a diagram illustrating an operation sequence of a second private network connection method (second method).

FIG. 23B is a diagram illustrating an operation sequence of the second private network connection method (second method).

FIG. 23C is a diagram illustrating the operation sequence of the second private network connection method (second method).

FIG. 24 is a diagram illustrating a third private network connection method.

FIG. 25A is a diagram illustrating an operation sequence of the third private network connection method (first method).

FIG. 25B is a diagram illustrating the operation sequence of the third private network connection method (first method).

FIG. 25C is a diagram illustrating the operation sequence of the third private network connection method (first method).

FIG. 25D is a diagram illustrating the operation sequence of the third private network connection method (first method).

FIG. 26A is a diagram illustrating an operation sequence of a third private network connection method (second method).

FIG. 26B is a diagram illustrating the operation sequence of the third private network connection method (second method).

FIG. 26C is a diagram illustrating the operation sequence of the third private network connection method (second method).

FIG. 27 is a diagram illustrating a fourth private network connection method (first method).

FIG. 28A is a diagram illustrating an operation sequence of the fourth private network connection method (first method).

FIG. 28B is a diagram illustrating the operation sequence of the fourth private network connection method (first method).

FIG. 28C is a diagram illustrating the operation sequence of the fourth private network connection method (first method).

FIG. 28D is a diagram illustrating the operation sequence of the fourth private network connection method (first method).

FIG. 29 is a diagram illustrating a fourth private network connection method (second method).

FIG. 30A is a diagram illustrating an operation sequence of the fourth private network connection method (second method).

FIG. 30B is a diagram illustrating the operation sequence of the fourth private network connection method (second method).

FIG. 30C is a diagram illustrating the operation sequence of the fourth private network connection method (second method).

FIG. 30D is a diagram illustrating the operation sequence of the fourth private network connection method (second method).

FIG. 31 is a diagram illustrating a fifth private network connection method.

FIG. 32A is a diagram illustrating an operation sequence of the fifth private network connection method.

FIG. 32B is a diagram illustrating the operation sequence of the fifth private network connection method.

FIG. 32C is a diagram illustrating the operation sequence of the fifth private network connection method.

FIG. 33 is a diagram illustrating a hardware configuration of the information processing device.

### DESCRIPTION OF EMBODIMENTS

Embodiments of the present invention will be described below with reference to the drawings. In the script in the drawings, the same parts are designated by the same reference numerals, and the description thereof will be omitted.

[Basic Configuration of Information Processing Device]

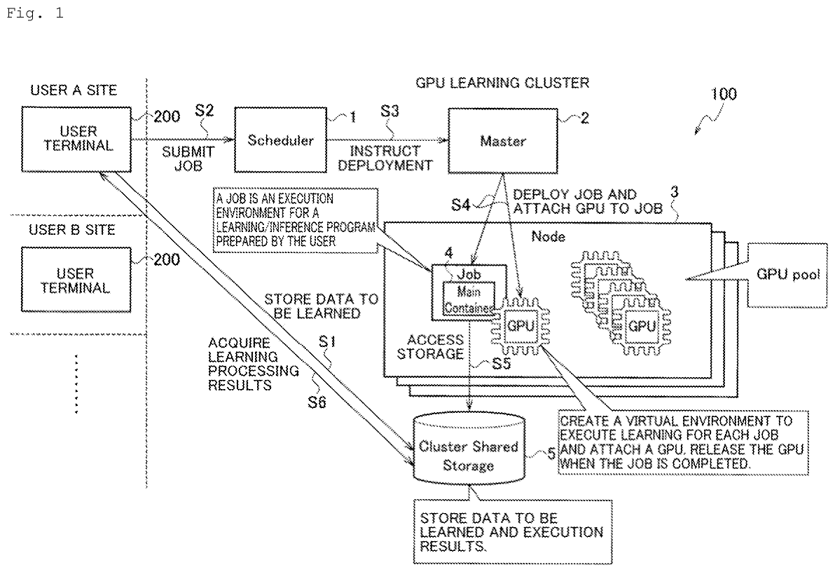

FIG. 1 is a diagram illustrating a basic configuration of an information processing device 100. The information processing device 100 includes a container type of GPU learning cluster that allocates a GPU resource for each execution of a job.

Jobs will first be described. A job defines a learning program that a user requests to execute and an execution environment for the learning program. For example, a job includes one or more learning programs to be executed, the execution order of the one or more learning programs, and the execution environment for the job to execute the learning program (virtual environment such as VM or container, runtime, OS, distribution, libraries, etc.), image file names such as of VM and container, and the like. In addition, the job may further include a procedure for automatically building the execution environment for the learning program, so that an image of that execution environment is automatically created.

As illustrated in FIG. 1, the information processing device 100 includes, for example, a scheduler 1, a master 2, a node 3, a main container 4, and a cluster shared storage 5.

The scheduler 1 has a function of receiving the submission of a job transmitted from a user terminal 200 located at the user site, monitoring the availability of GPU resources, and instructing the master 2 to deploy the job to a GPU resource if available.

The master 2 has a function of managing the node 3 in the GPU learning cluster and deploying (placing, installing, establishing, etc.) the job. Further, after the master 2 has a function of, in response to the instruction to execute the job, building the virtual environment defined in the job in the node 3 by a VM, a container, or the like, and executing the learning program defined in the job on the node 3. Further, the master 2 has a function of deleting the virtual environment for the job after the execution of the learning program defined in the job is completed.

The main container 4 is a container that is a virtual environment to execute the job. The virtual environment for the job always includes the main container 4, and may further include other containers. Note that the virtual environment for the job may be implemented as a VM, but in the present embodiment, it is a container.

The cluster shared storage 5 is a storage system that stores data to be learned by the job and the learning processing result. It can be accessed from the virtual environment for the job. In the present embodiment, it may be referred to as the storage for the sake of simplicity. The user terminal 200 stores the data to be learned in the storage 5 directly or indirectly by some means, and acquires the learning processing results from the storage 5 after the execution of learning is completed. Since it is necessary to store a large amount of data to be learned, storage technologies may be used such as Ceph (https://ceph.io/), GlusterFS (https://www.gluster.org/), Swift, RAID, and the like.

[Basic Operation of Information Processing Device]

The basic operation of the information processing device 100 will be described with reference to FIG. 1.

The user terminal 200 uploads the data to be learned to the storage 5 instructed by the cluster provider (step S1). The user terminal 200 registers the job to be executed in the scheduler 1 (step S2). The scheduler 1 schedules each job received from a plurality of user terminals 200 based on a priority, an estimated processing time, and the like, secures a GPU resource, and then instructs the master 2 to execute the job (step S3). The master 2 deploys the job to the node 3, attaches (allocates, adds, etc.) the secured GPU resource to the job, and causes the node 3 to execute the learning processing (step S4). The node 3 performs the learning processing of the job while reading the data to be learned uploaded to the storage 5 in advance, and stores the learning processing results in the storage 5 (step S5). The user terminal 200 acquires the learning processing results from the storage 5 after the execution of the job is completed (step S6).

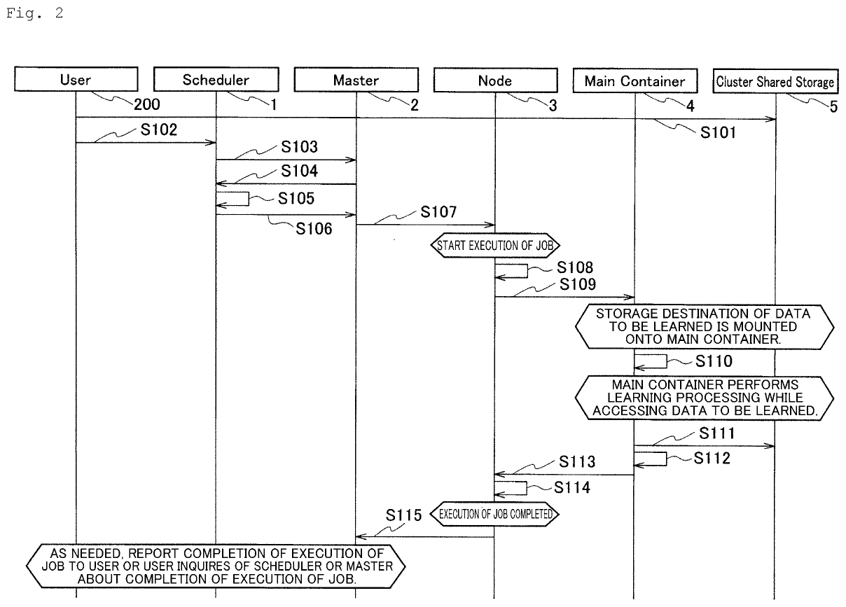

FIG. 2 is a diagram illustrating a basic operation sequence of the information processing device 100.

First, the user terminal 200 uploads the data to be learned to the storage 5 (step S101).

Next, the user terminal 200 registers the job for the learning program to be executed in the scheduler 1 (step S102). At this time, the user terminal 200 transmits definition information on the job, a storage location of the data to be learned, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S103), receives a report of the availability of GPU resources from the master 2 (step S104), and then schedules the execution time for the job based on the report (step S105).

Next, the scheduler 1 instructs the master 2 to deploy the job when the job is executed (step S106). At this time, the scheduler 1 transmits the definition information on the job, the storage location of the data to be learned, the authentication information such as a user ID, and the like to the master 2.

Next, the master 2 deploys the job to the node 3 (step S107). At this time, the master 2 transmits the definition information on the job, the storage location of the data to be learned, and the like to the node 3.

Next, based on the definition information on the job, the node 3 builds a virtual environment for the job (e.g., a namespace such as network namespace) (step S108), and creates a main container 4 (step S109). At this time, the node 3 makes a setting to allow the main container 4 to access the data to be learned in the storage 5 based on the storage location of the data to be learned. Accordingly, the storage destination of the data to be learned is mounted onto the main container 4.

Next, the main container 4 starts the learning processing of the job (step S110), performs the learning processing while accessing the data to be learned in the storage 5, and writes the learning processing results to the storage 5 (step S111). Then, after the learning processing is completed (step S112), the main container 4 reports the completion of execution of the main container 4 to the node 3 (step S113). Note that there are two methods for writing the learning processing results: a method of sequentially writing and a method of writing all at the end of the learning processing.

Finally, the node 3 deletes the virtual space and the like for the job (step S114), and reports the completion of execution of the job to the master 2 (step S115). After that, as needed, the master 2 reports the completion of execution of the job to the user terminal 200. Alternatively, the user terminal 200 inquires the scheduler 1 or the master 2 about the completion of execution of the job.

[Problems with Basic Configuration of Information Processing Device]

However, as described in Technical Problem, there are cases where the data to be learned cannot be taken out from the user site, or the data to be learned is not desired to be taken out from the user site.

Further, since the amount of the data to be learned is too large, it is difficult to upload the data to be learned to the storage 5 in advance, and in addition, there is also a case where it is desired to directly access the data to be learned at the user site online. For example, it is conceivable that the job selects data according to the learning situation and the metadata of the data to be learned (e.g., the date, the position information such as GPS (Global Positioning System), etc.).

Furthermore, in some cases, a series of data to be learned is not allowed to be taken out collectively because of corporate rules such as privacy, confidentiality, contract terms, and NDA (Non Disclosure Agreement), and legal compliance. For example, it is conceivable that the job confirms the metadata of the data to be learned, discards the metadata only when necessary, and then reads sensor data.

Thus, it is conceivable to add new functions to the master 2 and the node 3. However, it is preferable for the master 2 and the node 3 to use the conventional OSS as it is, and to avoid adding new functions or modifying it. The reason is that if it becomes necessary to further improve a new function that has been added or modified, a large amount of continuous development work will be required. In addition, the reason is also that the function to deal with a corner case like this cannot be expected to be maintained by the community because few users use it even if it contributes to upstream.

Further, in order to reduce the operational load, there is also an aspect in which the plain configuration is desired to be used without peripheral products for extended functions. For example, it may be preferable to avoid introducing special extended functions of Kubernetes. The reasons are that the extended functions have less information than the core functions of OSS, there is no support by vendors and the like, and the operational load is high.

[Improved Configuration of Information Processing Device]

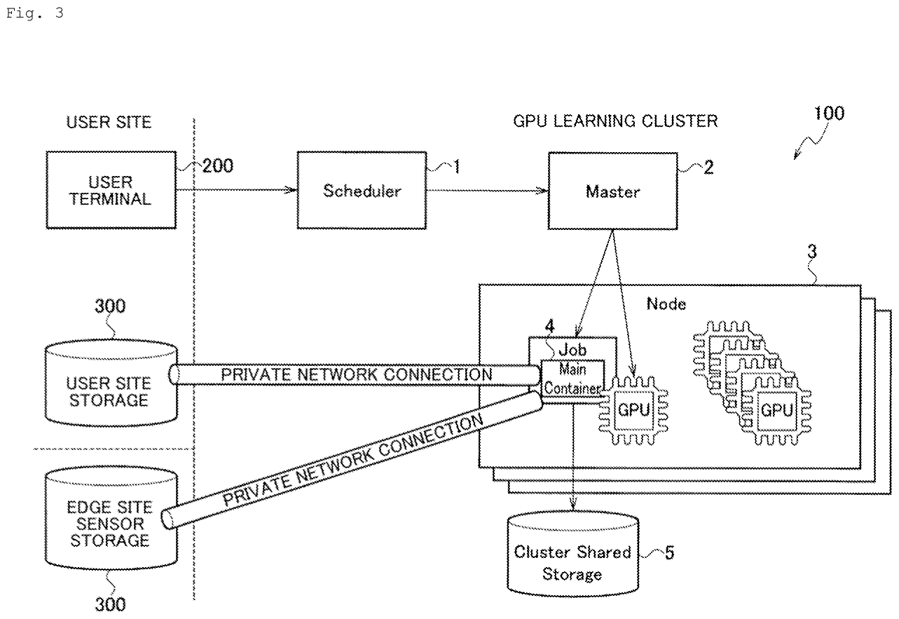

FIG. 3 is a diagram illustrating an improved configuration of the information processing device 100 illustrated in FIG. 1.

Accordingly, it is conceivable to provide a method of connecting the virtual environment for the job to a user site storage 300 over a private network (connection such as tunneling). The user site storage 300 is a storage installed in, for example, the user site, an edge site, or a site for collecting data from IoT sensor devices and the like, and is also a storage in which data to be learned is stored.

The information processing device 100 remotely accesses the user site storage 300 via the private network connection without storing the data to be learned in the local storage 5, reads the data to be subjected to learning processing online, and executes the learning processing. In this way, the information processing device 100 makes a private network connection to the user site storage 300, so that the degree of freedom in using the data to be learned can be improved.

[Problems with Improved Configuration of Information Processing Device]

However, as described in Technical Problem, the OSS that builds the GPU learning cluster has only the function of terminating frequently used communications such as HTTP and HTTPS (Hyper Text Transfer Protocol Secure), and does not have a function of terminating tunneling protocols such as IPSec (Security Architecture for Internet Protocol) and PPPoE (Point-to-Point Protocol over Ethernet).

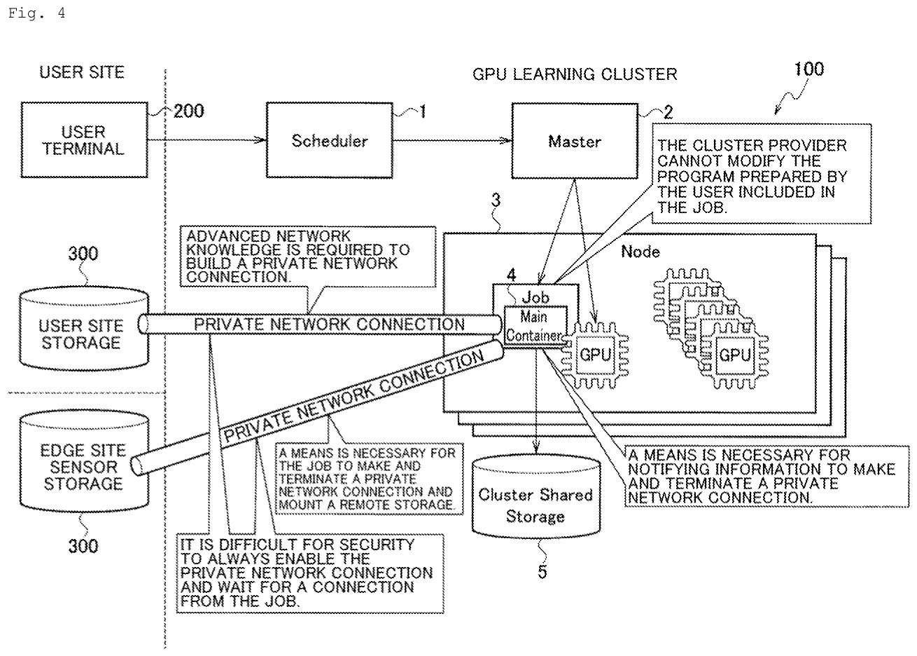

FIG. 4 is a diagram illustrating a problem with the information processing device 100 illustrated in FIG. 3.

Therefore, the virtual environment for a job needs, without impairing usability, a means for making and terminating a private network connection to the user site storage 300 and a means for mounting the user site storage 300 via the private network connection. In addition, a means for notifying information for making the private network connection and mounting is also needed.

Further, it may be difficult to always wait for a private network connection from a job at the user site. For example, it is necessary to temporarily disable the firewall of the user site during the period from the time when the job is submitted until the completion of execution of the job in order to execute the private network connection, but it may not be possible to disable the firewall because of security rules for the user site or the like. Further, the user is required to have advanced network knowledge such as IPsec in order to implement a private network connection.

[Another Improved Configuration of Information Processing Device]

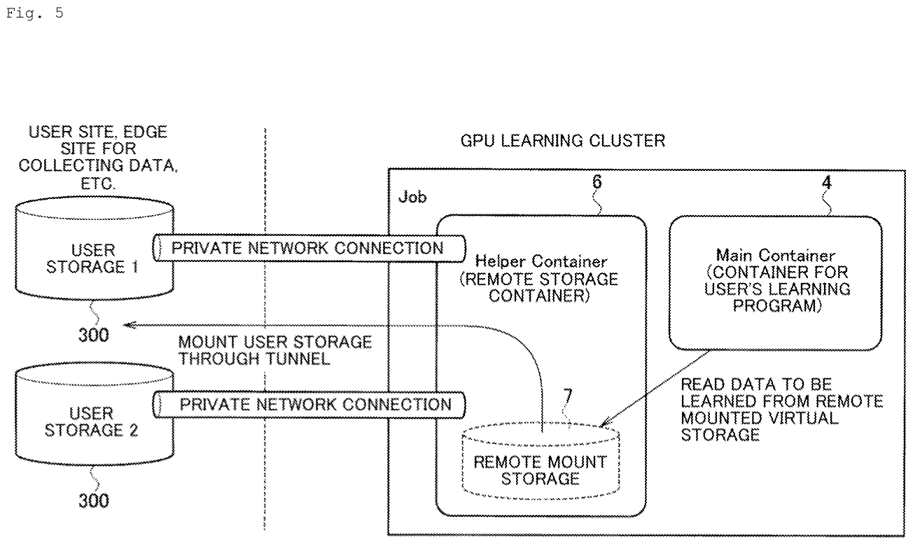

FIG. 5 is a diagram illustrating an improved configuration of the information processing device 100 illustrated in FIG. 3.

Accordingly, in the same virtual environment for the job as the main container 4, a helper container 6 is created that makes a private network connection to the user site storage 300 and mounts that storage 300. For example, the helper container 6 creates a tunnel interface for making the private network connection, obtains necessary information from environment variables and the like at the time of executing the job, and mounts the user site storage 300. Note that, for the environment variables and the like, the scheduler 1 instructs the master 2 to set them in the job.

The helper container 6 is placed together with the main container 4, and the main container 4 acquires data to be learned through a virtual remote mount storage 7 which is a mount point to the user site storage 300 in the helper container 6.

In other words, the GPU learning cluster includes the main container (first execution unit) 4 that executes a learning program of a job submitted by the user inside the job; and the helper container (second execution unit) 6 that executes processing of making a private network connection to the user site storage 300 to mount the storage 300 inside the job. Then, the main container 4 reads the data to be learned from the mounted user site storage 300, and executes the learning program of the job by using the data to be learned.

As a result, it is possible to realize a private network connection to the user site storage 300 without making any changes to the main container 4 in the job and without modifying the core functions of the OSS.

[Namespace]

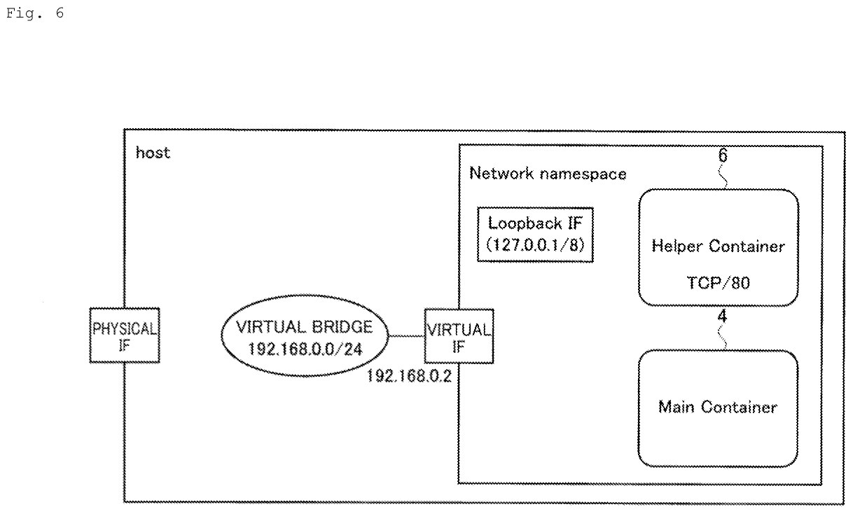

FIG. 6 is a diagram illustrating an image of a namespace.

In the case of the improved configuration illustrated in FIG. 5, there are two containers in the virtual environment for a job. However, if the two containers belong to the same namespace (e.g., Linux network namespace), the two containers share the network resources, and appear to be on the same host from the outside. Further, the two containers can communicate with each other via a local host address allocated to the loopback interface (loopback IF) or the like.

For example, as illustrated in FIG. 6, in the case where the helper container 6 listens on TCP port 80, when a packet is transmitted from the main container 4 to “127.0.0.1:80” or “192.168.0.2:80”, it arrives at the helper container 6. Further, in the case where the helper container 6 listens on TCP port 80, when the main container 4 tries to listen on TCP port 80, the main container 4 fails to listen because the port has already been used.

Accordingly, having two containers belong to the same namespace makes it possible to make the two containers look like one from the outside and to communicate the two containers with each other in the virtual environment for the job.

[Job Configuration Example]

A configuration example of a job will be described below.

[First Job Configuration Pattern]

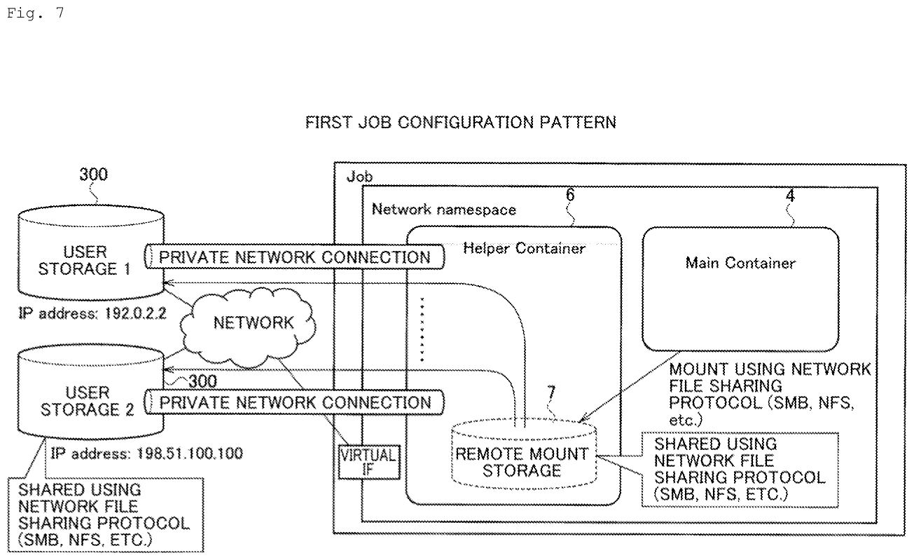

FIG. 7 is a diagram illustrating a first job configuration pattern.

In the first job configuration pattern, the helper container 6 mounts the user site storage 300 through the private network connection. For example, the helper container 6 mounts a shared folder whose IP address is “192.0.2.2” or “198.51.100.100” at the user site. The user site storage 300 shares the data to be learned with the helper container 6 by using a network file sharing protocol such as SMB or NFS.

Further, in the first job configuration pattern, the helper container 6 shares the data to be learned shared by that mounting with the main container 4 by using the network file sharing protocol. As a result, it appears that the virtual remote mount storage 7 similar to the user site storage 300 is in the helper container 6.

Further, in the first job configuration pattern, the main container 4 mounts the remote mount storage 7 in the helper container 6 by using the network file sharing protocol. Note that, since the helper container 6 and the main container 4 belong to the same namespace, the main container 4 can communicate with the helper container 6 via a local host address such as “127.0.0.1”, and can mount a shared folder with the local host address.

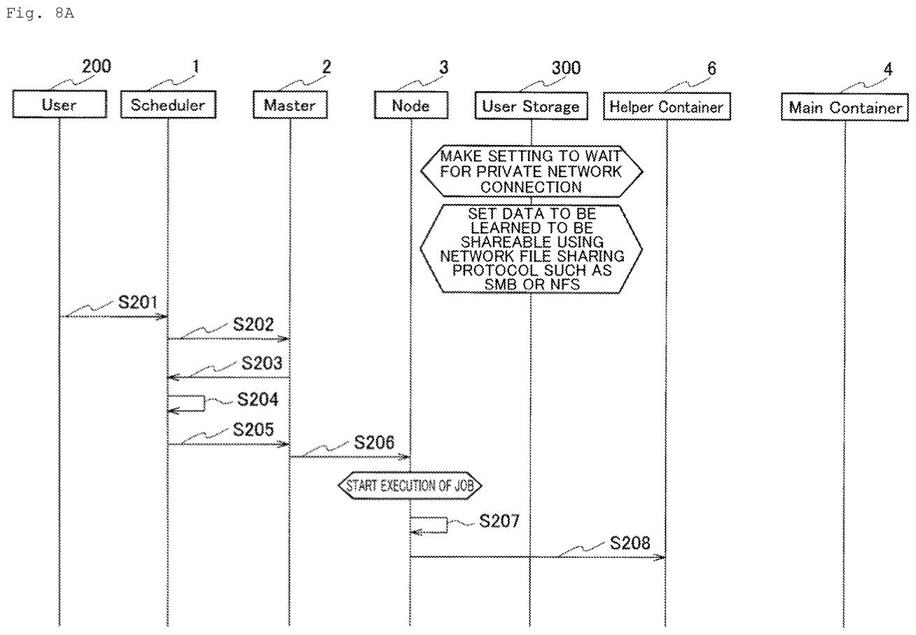

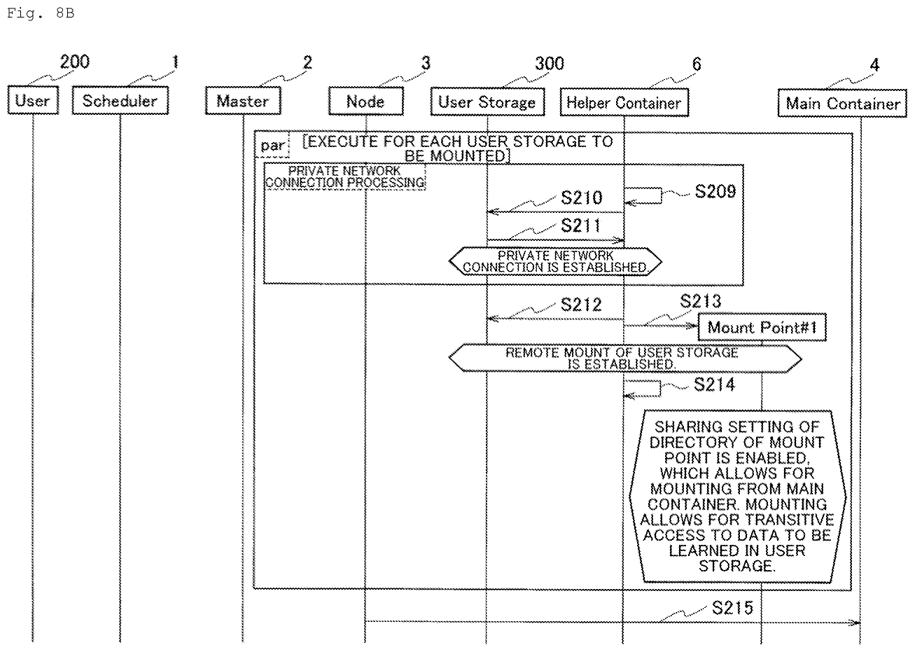

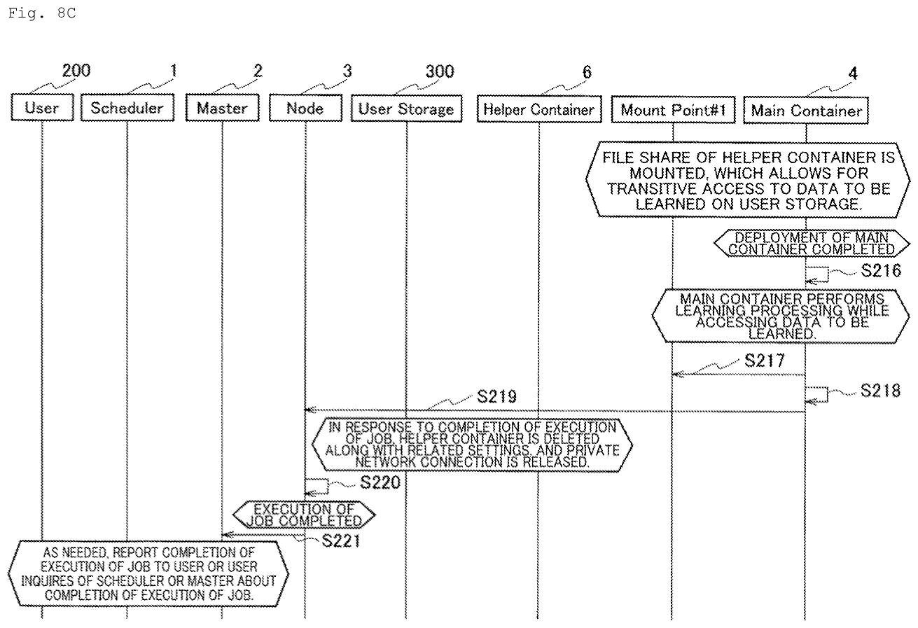

FIG. 8 is a diagram illustrating an operation sequence of the first job configuration pattern.

In advance, the user site storage 300 makes a setting to wait for a private network connection. Further, the user site storage 300 is set in advance so that the data to be learned can be shared by using the network file sharing protocol.

First, the user terminal 200 registers a job for a learning program to be executed in the scheduler 1 (step S201). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S202), receives a report of the availability of GPU resources from the master 2 (step S203), and then schedules the execution time for the job based on the report (step S204).

Next, the scheduler 1 instructs the master 2 to deploy the job when the job is executed (step S205). At this time, the scheduler 1 transmits the definition information on the job, the information on private network connection to the storage 300, the information on access to data to be learned, the authentication information such as a user ID, and the like to the master 2.

Next, the master 2 deploys the job to the node 3 (step S206). At this time, the master 2 transmits the definition information on the job, the information on private network connection to the storage 300, and the information on access to data to be learned to the node 3.

Next, based on the definition information on the job, the node 3 builds a virtual environment for the job (step S207), and creates a helper container 6 (step S208). At this time, the node 3 transmits the information on private network connection to the storage 300 and the information on access to data to be learned to the helper container 6.

Next, based on the information on private network connection to the storage 300, the helper container 6 sets the configuration of the private network connection internally (step S209), and requests the storage 300 for the private network connection (step S210), and that storage 300 accepts the private network connection, accordingly (step S211). As a result, the private network connection is established between the helper container 6 and the storage 300.

Next, based on the information on access to data to be learned, the helper container 6 mounts the data to be learned in the storage 300 by using the network file sharing protocol via the private network connection (step S212). Further, the helper container 6 configures mount point #1 (step S213). As a result, a remote mount of the storage 300 is established.

Next, the helper container 6 sets the network file sharing protocol internally, and sets mount point #1 to be in a transitive shared state with the main container 4 (step S214). As a result, at mount point #1, the shared setting of the directory of mount point #1 is enabled, which allows for mounting from the main container 4. Further, that mounting allows for transitive access to the data to be learned in the storage 300.

Next, the node 3 creates a main container 4 and mounts the file share of the helper container 6 (step S215). As a result, the main container 4 is allowed for transitive access to the data to be learned in the storage 300.

Next, the main container 4 starts the learning processing of the job (step S216), performs the learning processing while accessing the data to be learned, and writes the learning processing results to mount point #1 (step S217).

Next, after the learning processing is completed (step S218), the main container 4 reports the completion of execution of the main container 4 to the node 3 (step S219). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Finally, the node 3 deletes the virtual space and the like for the job (step S220), and reports the completion of execution of the job to the master 2 (step S221). After that, as needed, the master 2 reports the completion of execution of the job to the user terminal 200. Alternatively, the user terminal 200 inquires the scheduler 1 or the master 2 about the completion of execution of the job.

[Second Job Configuration Pattern]

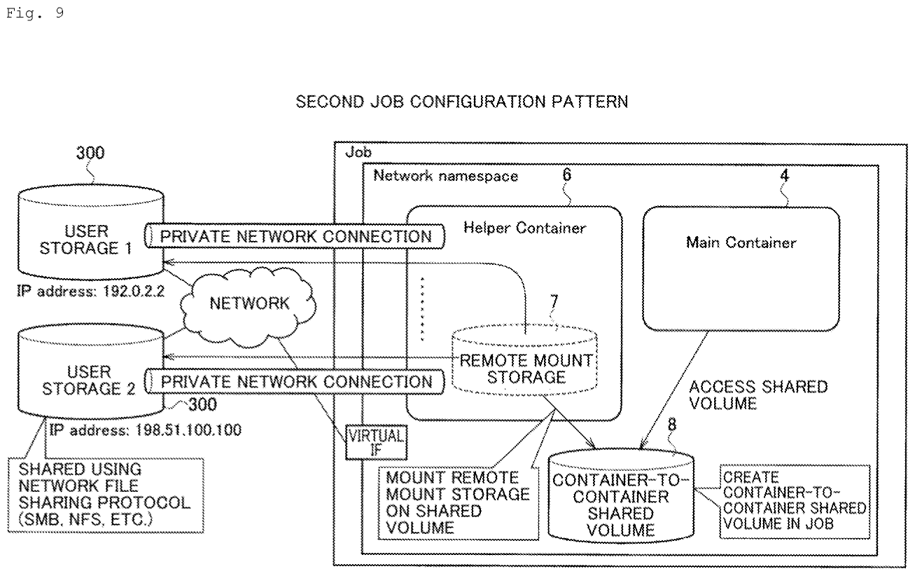

FIG. 9 is a diagram illustrating a second job configuration pattern.

In the second job configuration pattern, a container-to-container shared volume 8 which is shared between two containers is created in a job so that it can be accessed from each of the helper container 6 and the main container 4.

Further, in the second job configuration pattern, the helper container 6 mounts the user site storage 300 through the private network connection. For example, the helper container 6 mounts a shared folder whose IP address is “192.0.2.2” or “198.51.100.100” at the user site. Further, the mount point at that time is set in a folder in the container-to-container shared volume 8 so that it can be accessed from the main container 4. The user site storage 300 shares the data to be learned with the helper container 6 by using a network file sharing protocol.

Further, in the second job configuration pattern, the main container 4 accesses the user site storage 300 via the mount by the helper container 6 by accessing the container-to-container shared volume 8.

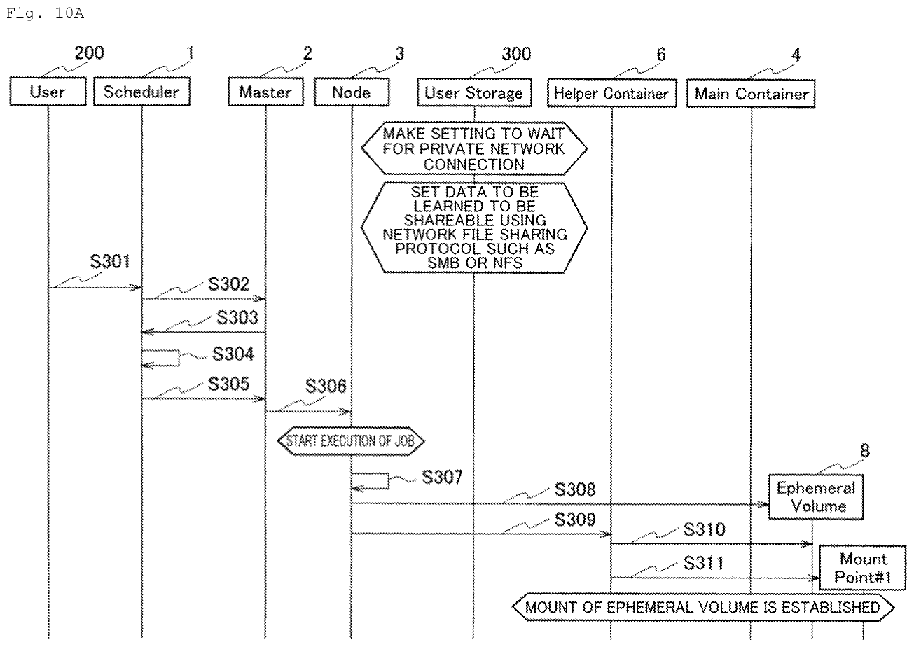

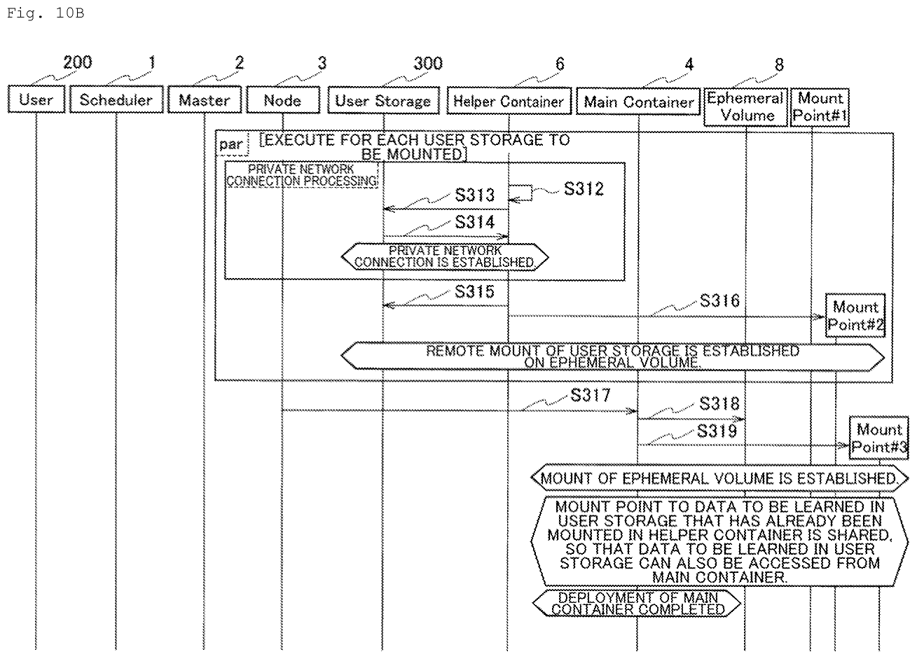

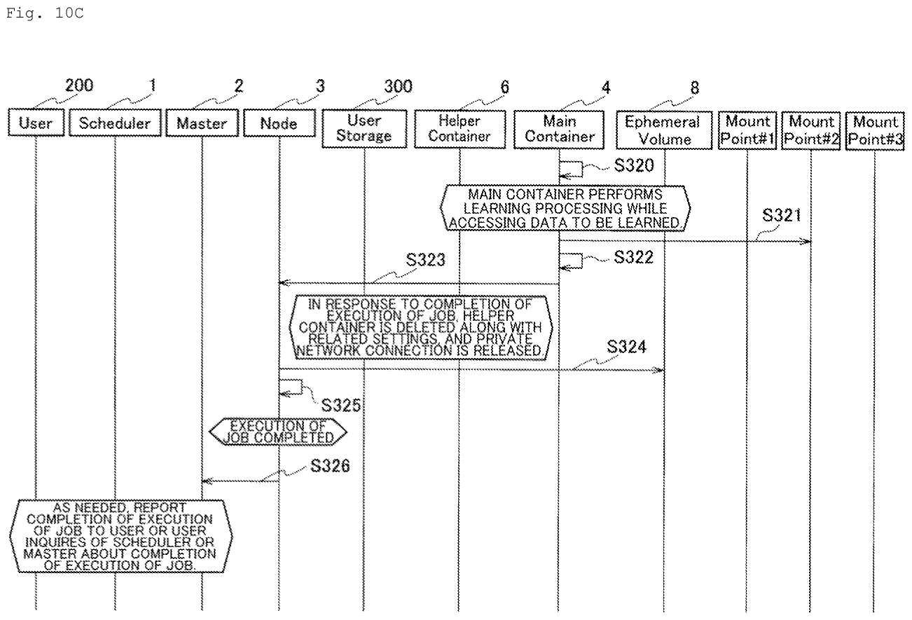

FIG. 10 is a diagram illustrating an operation sequence of the second job configuration pattern.

In advance, the user site storage 300 makes a setting to wait for a private network connection. Further, the user site storage 300 is set in advance so that the data to be learned can be shared by using the network file sharing protocol.

First, the user terminal 200 registers a job for a learning program to be executed in the scheduler 1 (step S301). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S302), receives a report of the availability of GPU resources from the master 2 (step S303), and then schedules the execution time for the job based on the report (step S304).

Next, the scheduler 1 instructs the master 2 to deploy the job when the job is executed (step S305). At this time, the scheduler 1 transmits the definition information on the job, the information on private network connection to the storage 300, the information on access to data to be learned, the authentication information such as a user ID, and the like to the master 2.

Next, the master 2 deploys the job to the node 3 (step S306). At this time, the master 2 transmits the definition information on the job, the information on private network connection to the storage 300, and the information on access to data to be learned to the node 3.

Next, based on the definition information on the job, the node 3 builds a virtual environment for the job (step S307).

Next, the node 3 creates a container-to-container shared volume (ephemeral volume) 8 (step S308). The container-to-container shared volume 8 is a volatile temporary volume that is valid only for the period in which the job is valid, and can be shared between the two containers in the job. Instead of or in addition to the ephemeral volume, a mechanism that allows a volume on the node such as a hostPath or a local volume to be shared from the container in the job may be utilized.

Next, the node 3 creates a helper container 6 (step S309). At this time, the node 3 transmits the information on private network connection to the storage 300 and the information on access to data to be learned to the helper container 6.

Next, the helper container 6 mounts the container-to-container shared volume 8 (step S310) and configures mount point #1 (step S311). As a result, the mount of the container-to-container shared volume 8 is established by the helper container 6.

Next, based on the information on private network connection to the storage 300, the helper container 6 sets the configuration of the private network connection internally (step S312) and requests the storage 300 for the private network connection (step S313), and that storage 300 accepts the private network connection, accordingly (step S314). As a result, the private network connection is established between the helper container 6 and the storage 300.

Next, based on the information on access to data to be learned, the helper container 6 mounts the data to be learned in the storage 300 by using the network file sharing protocol via the private network connection (step S315).

Next, the helper container 6 configures mount point #2 under mount point #1 (step S316). For example, the helper container 6 mounts the data to be learned in the storage 300 onto the container-to-container shared volume 8 by specifying as a mount point a directory under the mount point of the container-to-container shared volume 8. As a result, a remote mount of the user site storage 300 is established on the container-to-container shared volume 8.

Next, the node 3 creates a main container 4 (step S317). Next, the main container 4 mounts the container-to-container shared volume 8 (step S318) and configures mount point #3 (step S319). As a result, the mount of the container-to-container shared volume 8 is established by the main container 4. Further, the mount to the data to be learned in the storage 300 that has already been mounted in the helper container 6 is shared, so that the data to be learned in the storage 300 can also be accessed from the main container 4.

Next, the main container 4 starts the learning processing of the job (step S320), performs the learning processing while accessing the data to be learned, and writes the learning processing results to mount point #2 (step S321).

Next, after the learning processing is completed (step S322), the main container 4 reports the completion of execution of the main container 4 to the node 3 (step S323). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #2.

Next, the node 3 discards the container-to-container shared volume 8 shared between the main container 4 and the helper container 6 (step S324), deletes the virtual space and the like for the job (step S325), and then reports the completion of execution of the job to the master 2 (step S326). After that, as needed, the master 2 reports the completion of execution of the job to the user terminal 200. Alternatively, the user terminal 200 inquires the scheduler 1 or the master 2 about the completion of execution of the job.

[Third Job Configuration Pattern]

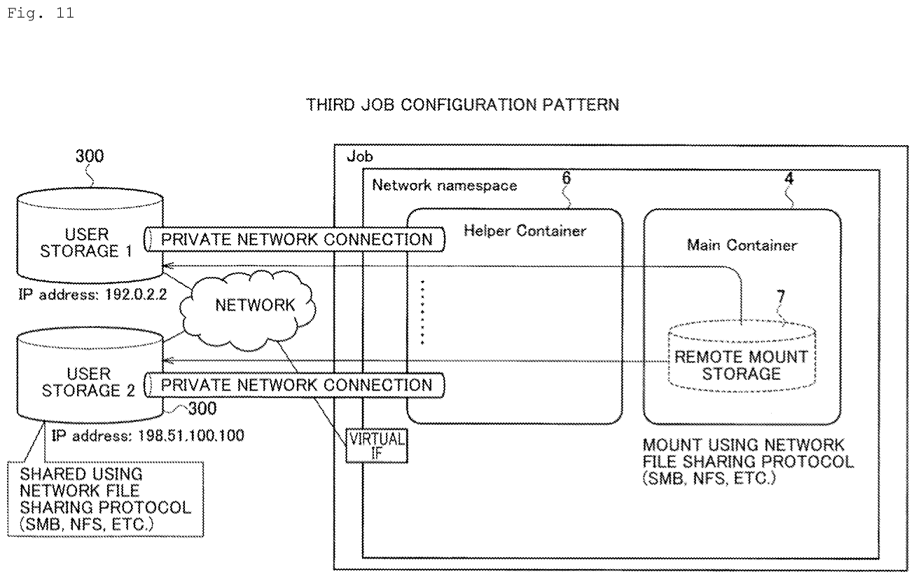

FIG. 11 is a diagram illustrating a third job configuration pattern.

In the third job configuration pattern, the user site storage 300 shares the data to be learned with the job by using a network file sharing protocol.

Further, in the third job configuration pattern, the helper container 6 makes a private network connection with the user site storage 300.

Further, in the third job configuration pattern, the main container 4 accesses the user site storage 300 by the network file sharing protocol via the private network connection.

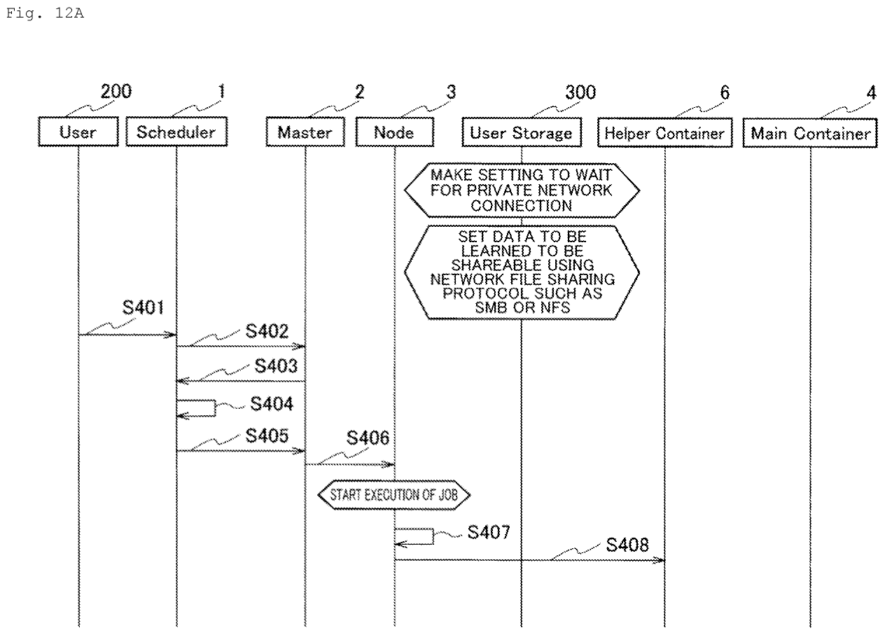

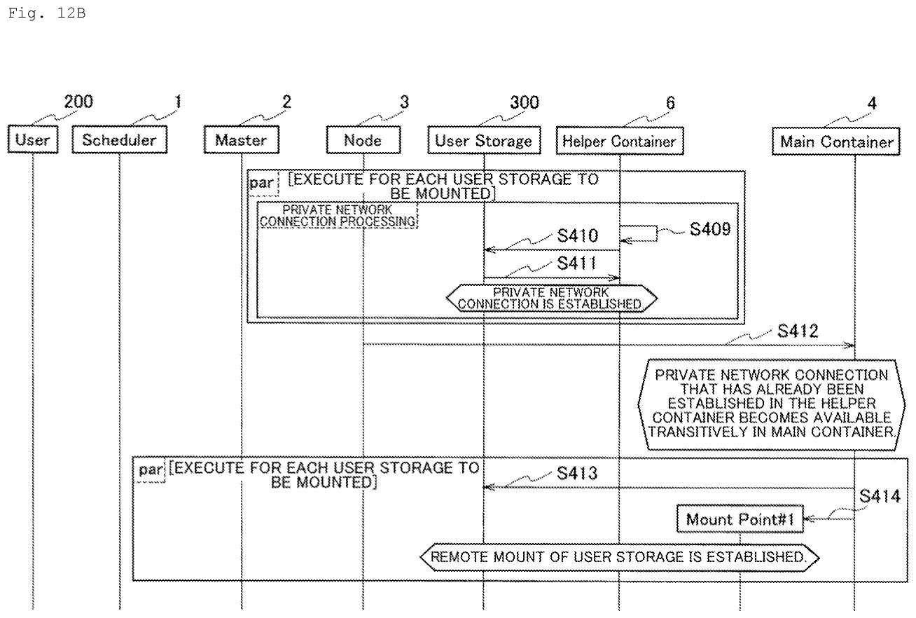

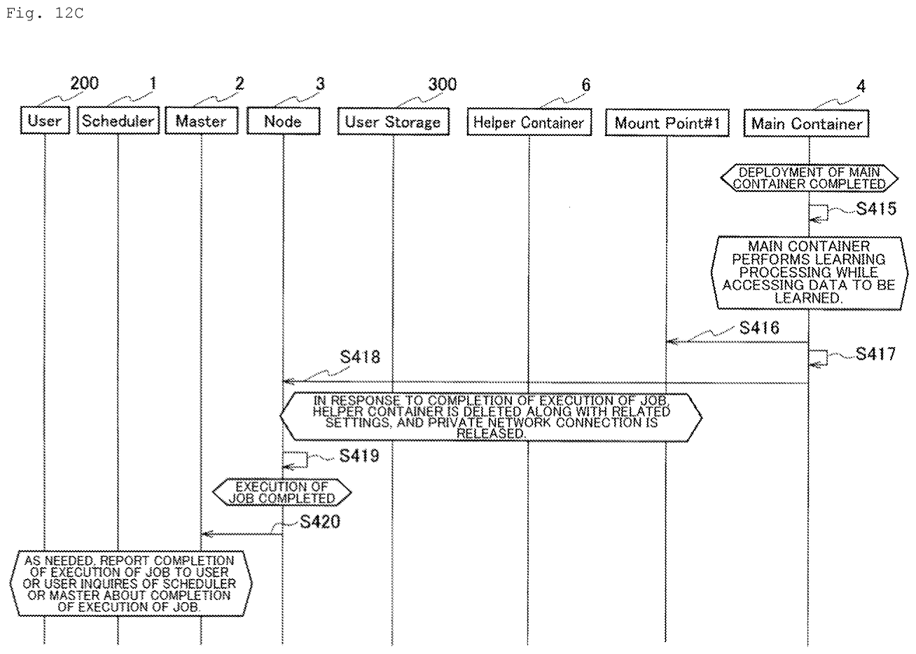

FIG. 12 is a diagram illustrating an operation sequence of the third job configuration pattern.

In advance, the user site storage 300 makes a setting to wait for a private network connection. Further, the user site storage 300 is set in advance so that the data to be learned can be shared by using the network file sharing protocol.

First, the user terminal 200 registers a job for a learning program to be executed in the scheduler 1 (step S401). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S402), receives a report of the availability of GPU resources from the master 2 (step S403), and then schedules the execution time for the job based on the report (step S404).

Next, the scheduler 1 instructs the master 2 to deploy the job when the job is executed (step S405). At this time, the scheduler 1 transmits the definition information on the job, the information on private network connection to the storage 300, the information on access to data to be learned, the authentication information such as a user ID, and the like to the master 2.

Next, the master 2 deploys the job to the node 3 (step S406). At this time, the master 2 transmits the definition information on the job, the information on private network connection to the storage 300, and the information on access to data to be learned to the node 3.

Next, based on the definition information on the job, the node 3 builds a virtual environment for the job (step S407), and creates a helper container 6 (step S408). At this time, the node 3 transmits the information on private network connection to the storage 300 to the helper container 6.

Next, based on the information on private network connection to the storage 300, the helper container 6 sets the configuration of the private network connection internally (step S409), requests the private network connection to the storage 300 (step S410), and accordingly that storage 300 accepts the private network connection (step S411). As a result, the private network connection is established between the helper container 6 and the storage 300.

Next, the node 3 creates a main container 4 and transmits the information on access to data to be learned to the main container 4 (step S412). As a result, the private network connection that has already been established in the helper container 6 becomes available transitively in the main container 4.

Next, based on the information on access to data to be learned, the main container 4 mounts the data to be learned in the storage 300 by using the network file sharing protocol via the private network connection (step S413), and configures mount point #1 (step S414). As a result, a remote mount of the storage 300 is established.

Next, the main container 4 starts the learning processing of the job (step S415), performs the learning processing while accessing the data to be learned, and writes the learning processing results to mount point #1 (step S416).

Next, after the learning processing is completed (step S417), the main container 4 reports the completion of execution of the main container 4 to the node 3 (step S418). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Finally, the node 3 deletes the virtual space and the like for the job (step S419), and reports the completion of execution of the job to the master 2 (step S420). After that, as needed, the master 2 reports the completion of execution of the job to the user terminal 200. Alternatively, the user terminal 200 inquires the scheduler 1 or the master 2 about the completion of execution of the job.

[Fourth Job Configuration Pattern]

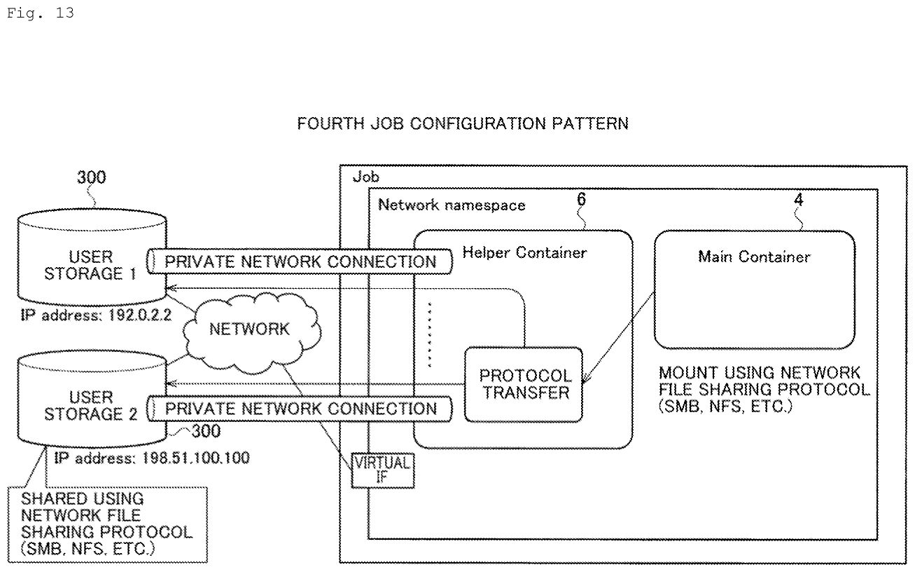

FIG. 13 is a diagram illustrating a fourth job configuration pattern.

In the fourth job configuration pattern, the user site storage 300 shares the data to be learned with the helper container 6 by using a network file sharing protocol.

Further, in the fourth job configuration pattern, the helper container 6 transfers, to the IP address of the user site of such as “192.0.2.2” or “198.51.100.100” through the private network connection, a communication that is from the main container 4 and that uses the network file sharing protocol addressed to a local host address allocated to a loopback interface in the namespace.

As a result, when the main container 4 accesses the file share of the helper container 6, the main container 4 is allowed for transparent access to the user site storage 300 by the protocol transfer of the helper container 6.

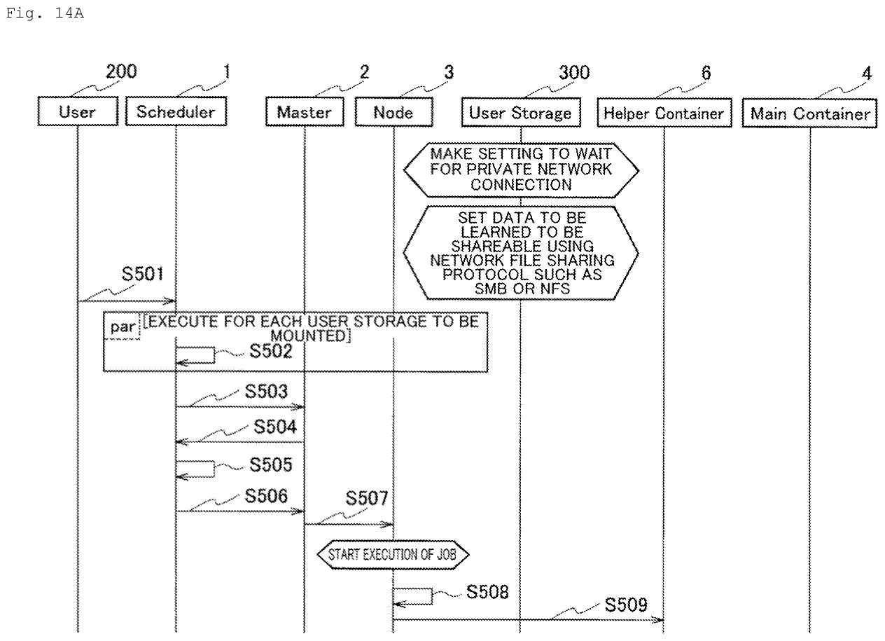

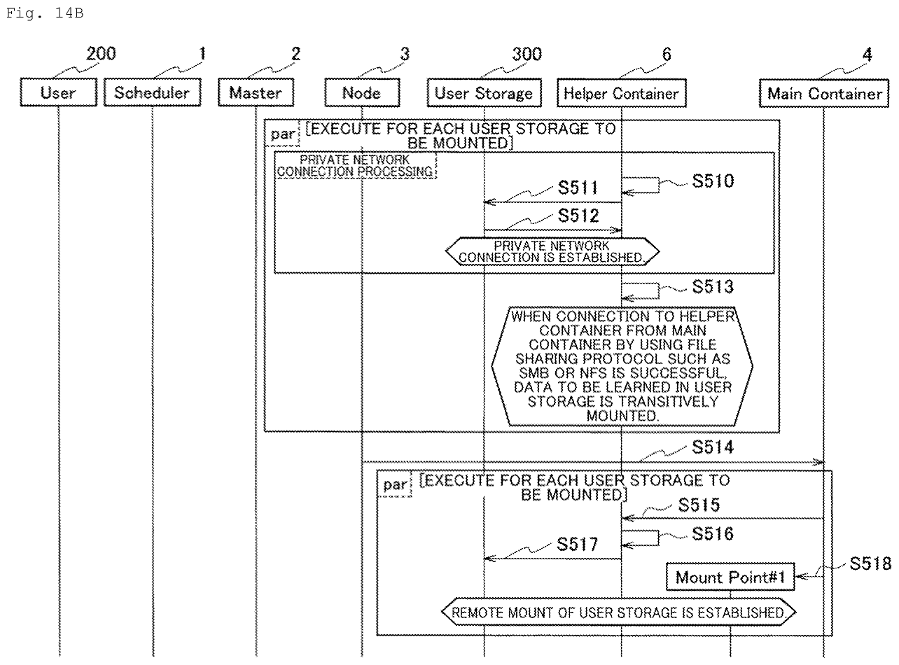

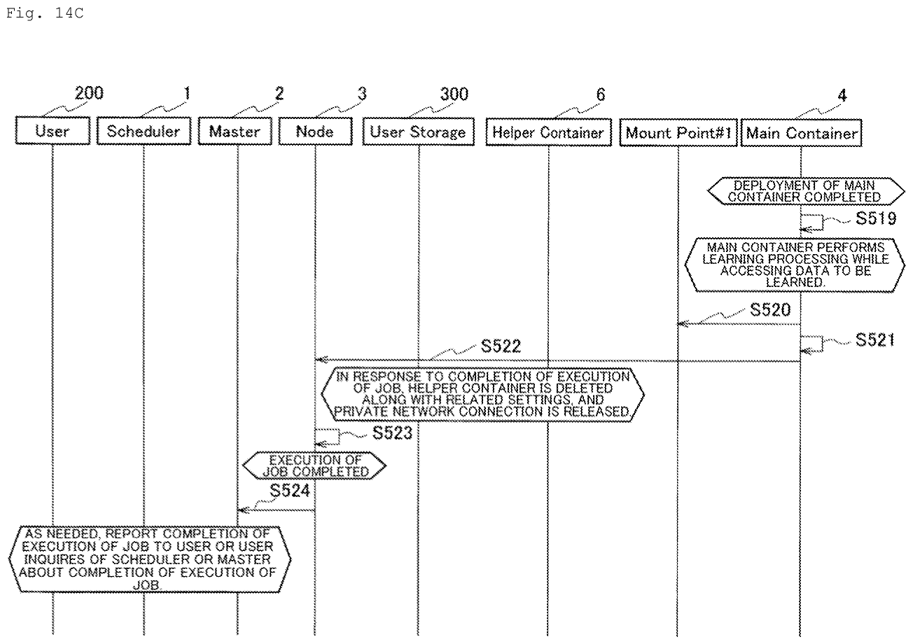

FIG. 14 is a diagram illustrating an operation sequence of the fourth job configuration pattern.

In advance, the user site storage 300 makes a setting to wait for a private network connection. Further, the user site storage 300 is set in advance so that the data to be learned can be shared by using the network file sharing protocol.

First, the user terminal 200 registers a job for a learning program to be executed in the scheduler 1 (step S501). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, based on the information on private network connection to the storage 300 and the information on access to data to be learned, the scheduler 1 creates protocol transfer information required for protocol transfer in the helper container 6 for each user site storage 300 to be mounted (step S502). Specifically, the scheduler 1 creates wait point information for waiting for the file sharing protocol or the like from the main container 4 in the helper container 6, and information for determining the information on private network connection to the storage 300 which is the transfer destination of the file sharing protocol or the like arrived at the wait point. Note that the access to the data to be learned from the main container 4 is to the wait point information created here for the helper container 6.

Next, the scheduler 1 inquires of the master 2 about the availability of GPU resources (step S503), receives a report of the availability of GPU resources from the master 2 (step S504), and then schedules the execution time for the job based on the report (step S505).

Next, the scheduler 1 instructs the master 2 to deploy the job when the job is executed (step S506). At this time, the scheduler 1 transmits the definition information on the job, the information on private network connection to the storage 300, the information on access to data to be learned, the protocol transfer information, the authentication information such as a user ID, and the like to the master 2.

Next, the master 2 deploys the job to the node 3 (step S507). At this time, the master 2 registers in the node 3 the definition information on the job, the information on private network connection to the storage 300, the information on access to data to be learned, and the protocol transfer information.

Next, based on the definition information on the job, the node 3 builds a virtual environment for the job (step S508), and creates a helper container 6 (step S509). At this time, the node 3 transmits the information on private network connection to the storage 300, the information on access to data to be learned, and the protocol transfer information to the helper container 6 (step S509).

Next, based on the information on private network connection to the storage 300, the helper container 6 sets the configuration of the private network connection internally (step S510), requests the private network connection to the storage 300 (step S511), and accordingly that storage 300 accepts the private network connection (step S512). As a result, the private network connection is established between the helper container 6 and the storage 300.

Next, based on the protocol transfer information, the helper container 6 starts a protocol wait function of waiting for a file sharing protocol from the main container 4 and a protocol transfer function of performing protocol transfer via the private network connection in response to receiving the file sharing protocol (step S513). As a result, when the file sharing protocol from the main container 4 arrives at the helper container 6, the data to be learned in the storage 300 is transitively mounted.

Next, the node 3 creates a main container 4 and transmits the wait point information for the helper container 6 to the main container 4 (step S514). As a result, the main container 4 is allowed for transitive access to the data to be learned by accessing the wait point information for the helper container 6. Note that the node 3 also registers, in the main container 4 in advance, the authentication information required for accessing the data to be learned.

Next, the main container 4 starts mounting the data to be learned in the user site storage 300 through the helper container 6 by using the file sharing protocol (step S515). The helper container 6 performs transfer processing of the file sharing protocol (step S516), and mounts the data to be learned in the storage 300 (step S517). After that, the main container 4 configures mount point #1 (step S518). As a result, a remote mount of the storage 300 is established.

Next, the main container 4 starts the learning processing of the job (step S519), performs the learning processing while accessing the data to be learned, and writes the learning processing results to mount point #1 (step S520).

Next, after the learning processing is completed (step S521), the main container 4 reports the completion of execution of the main container 4 to the node 3 (step S522). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Finally, the node 3 deletes the virtual space and the like for the job (step S523), and reports the completion of execution of the job to the master 2 (step S524). After that, as needed, the master 2 reports the completion of execution of the job to the user terminal 200. Alternatively, the user terminal 200 inquires the scheduler 1 or the master 2 about the completion of execution of the job.

[Fifth Job Configuration Pattern]

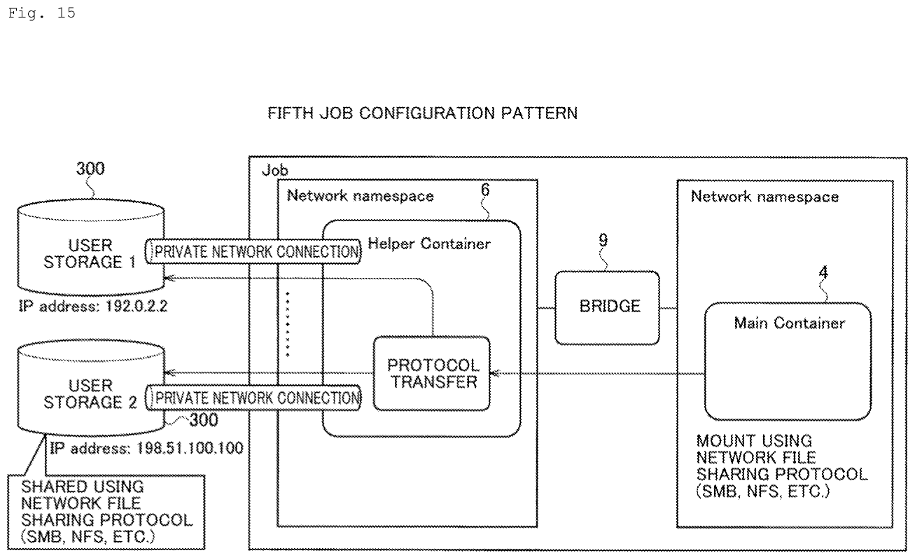

FIG. 15 is a diagram illustrating a fifth job configuration pattern.

In the fifth job configuration pattern, the helper container 6 and the main container 4 are placed in two different namespaces, and the namespaces and containers are connected by a communication bridge 9.

Further, in the fifth job configuration pattern, the user site storage 300 shares the data to be learned with the helper container 6 by using a network file sharing protocol.

Further, in the fifth job configuration pattern, the helper container 6 transfers, to the IP address of the user site of such as “192.0.2.2” or “198.51.100.100” through the private network connection, a communication that using the network file sharing protocol addressed to a local host address from the main container 4.

As a result, when the main container 4 accesses the file share of the helper container 6, the main container 4 is allowed for transparent access to the user site storage 300 by the protocol transfer.

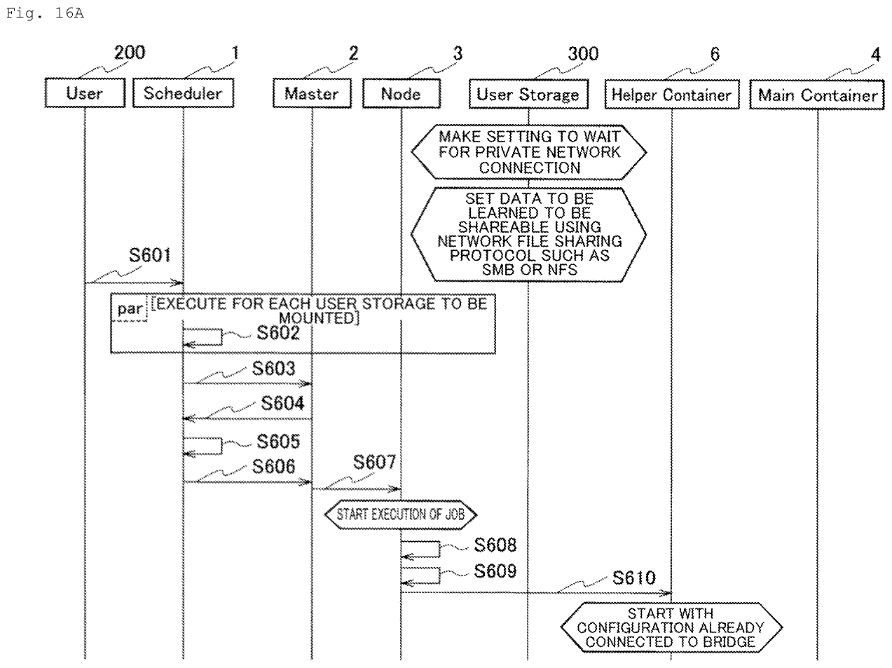

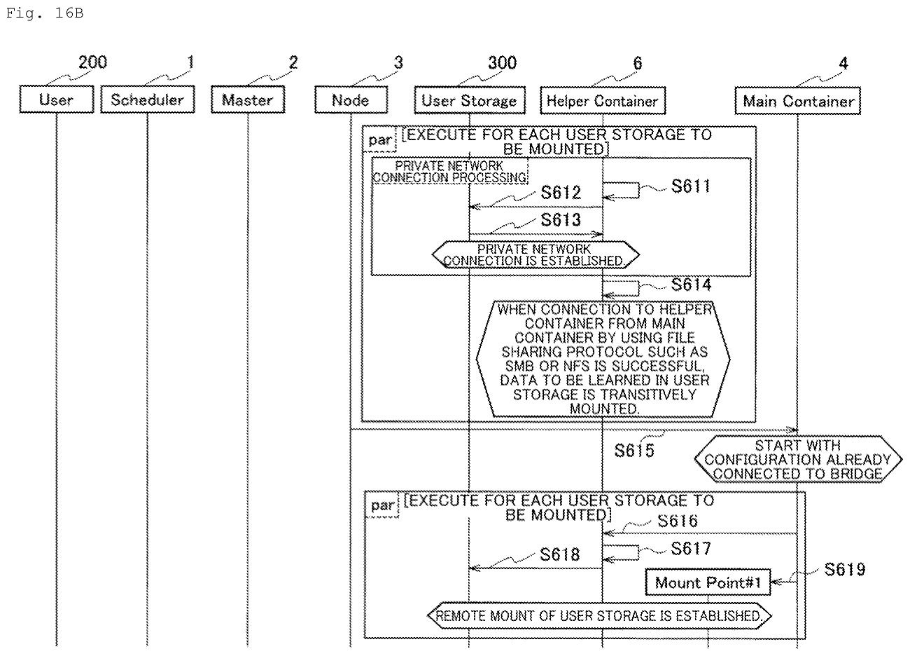

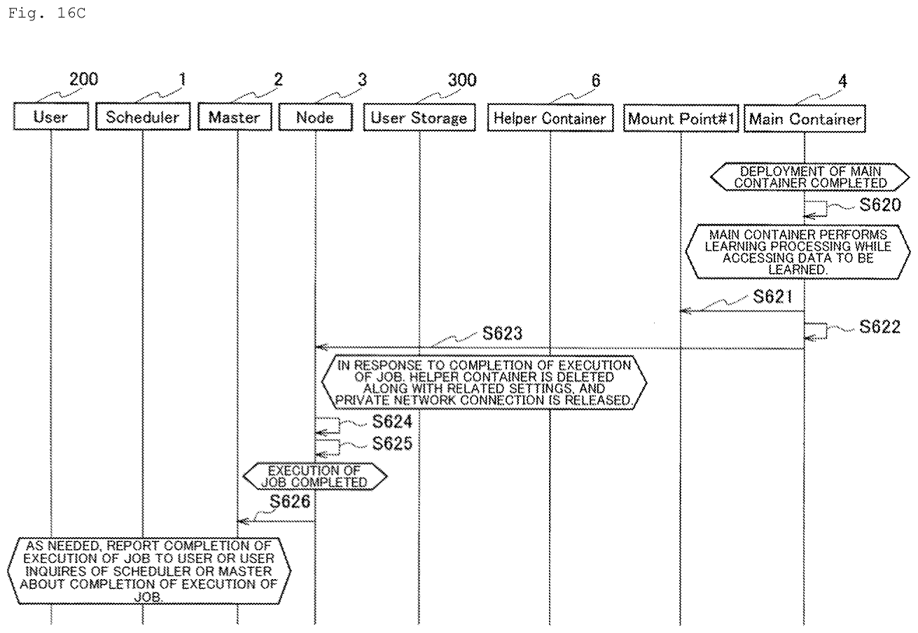

FIG. 16 is a diagram illustrating an operation sequence of the fifth job configuration pattern.

In advance, the user site storage 300 makes a setting to wait for a private network connection. Further, the user site storage 300 is set in advance so that the data to be learned can be shared by using the network file sharing protocol.

First, the user terminal 200 registers a job for a learning program to be executed in the scheduler 1 (step S601). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, based on the information on private network connection to the storage 300 and the information on access to data to be learned, the scheduler 1 creates protocol transfer information required for protocol transfer in the helper container 6 for each user site storage 300 to be mounted (step S602). Specifically, the scheduler 1 creates wait point information for waiting for the file sharing protocol or the like from the main container 4 in the helper container 6, and information for determining the information on private network connection to the storage 300 which is the transfer destination of the file sharing protocol or the like arrived at the wait point. Note that the access to the data to be learned from the main container 4 is to the wait point information created here for the helper container 6.

Next, the scheduler 1 inquires of the master 2 about the availability of GPU resources (step S603), receives a report of the availability of GPU resources from the master 2 (step S604), and then schedules the execution time for the job based on the report (step S605).

Next, the scheduler 1 instructs the master 2 to deploy the job when the job is executed (step S606). At this time, the scheduler 1 transmits the definition information on the job, the information on private network connection to the storage 300, the information on access to data to be learned, the protocol transfer information, the authentication information such as a user ID, and the like to the master 2.

Next, the master 2 deploys the job to the node 3 (step S607). At this time, the master 2 registers in the node 3 the definition information on the job, the information on private network connection to the storage 300, the information on access to data to be learned, and the protocol transfer information.

Next, based on the definition information on the job, the node 3 builds a virtual environment for the job (step S608), and creates a communication bridge 9 for connecting the main container 4 and the helper container 6 (step S609). After that, the node 3 creates a helper container 6 (step S610). At this time, the node 3 transmits the information on private network connection to the storage 300, the information on access to data to be learned, and the protocol transfer information to the helper container 6.

Next, the helper container 6 is started with the configuration already connected to the communication bridge 9, and based on the information on private network connection to the storage 300, sets a configuration for the private network connection internally (step S611). Then, the helper container 6 requests the private network connection to the storage 300 (step S612), and accordingly that storage 300 accepts the private network connection (step S613). As a result, the private network connection is established between the helper container 6 and the storage 300.

Next, based on the protocol transfer information, the helper container 6 starts a protocol wait function of waiting for a file sharing protocol from the main container 4 and a protocol transfer function of performing protocol transfer via the private network connection in response to receiving the file sharing protocol (step S614). As a result, when the file sharing protocol from the main container 4 is communicatively connected to the helper container 6, the data to be learned in the storage 300 is transitively mounted.

Next, the node 3 creates a main container 4 and transmits the wait point information for the helper container 6 to the main container 4 (step S615). As a result, the main container 4 is allowed for transitive access to the data to be learned by accessing the wait point information for the helper container 6. Note that the node 3 also registers, in the main container 4 in advance, the authentication information required for accessing the data to be learned.

Next, the main container 4 is started with the configuration already connected to the communication bridge 9, and starts mounting the data to be learned in the user site storage 300 through the helper container 6 by using the file sharing protocol (step S616). The helper container 6 performs transfer processing of the file sharing protocol (step S617), and mounts the data to be learned in the storage 300 (step S618). After that, the main container 4 configures mount point #1 (step S619). As a result, a remote mount of the storage 300 is established.

Next, the main container 4 starts the learning processing of the job (step S620), performs the learning processing while accessing the data to be learned, and writes the learning processing results to mount point #1 (step S621).

Next, after the learning processing is completed (step S622), the main container 4 reports the completion of execution of the main container 4 to the node 3 (step S623). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Finally, the node 3 deletes the communication bridge 9 (step S624), deletes the virtual space of the job (step S625), and reports the completion of execution of the job to the master 2 (step S626). After that, as needed, the master 2 reports the completion of execution of the job to the user terminal 200. Alternatively, the user terminal 200 inquires the scheduler 1 or the master 2 about the completion of execution of the job.

[Sixth Job Configuration Pattern]

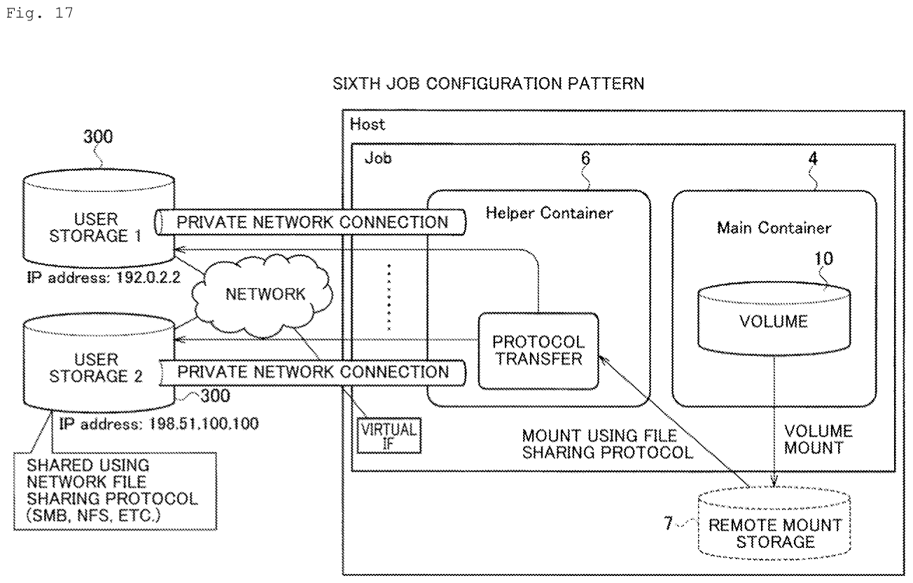

FIG. 17 is a diagram illustrating a sixth job configuration pattern.

In the sixth job configuration pattern, the user site storage 300 shares the data to be learned with the helper container 6 by using a network file sharing protocol.

Further, in the sixth job configuration pattern, the helper container 6 transfers, to the IP address of the user site of such as “192.0.2.2” or “198.51.100.100” through the private network connection, a communication using the network file sharing protocol addressed to itself. Specifically, the helper container 6 discloses a transfer port, which is defined in the job.

Further, in the sixth job configuration pattern, a mount setting for the network file sharing protocol transferred by the helper container 6 is added to the definition for the job, so that the mount is set to be referred to as a volume 10 in the main container 4. When the job is deployed, the file share of the helper container 6 is mounted in the host according to the definition for the job, so that its contents can be accessed from the main container 4.

Further, in the sixth job configuration pattern, when the main container 4 accesses the volume 10, a communication occurs in the helper container 6 by the network file sharing protocol via the mount setting in the host, and the communication is transferred to the user site storage 300 by the helper container 6. As a result, the main container 4 is allowed for access to the user site storage 300.

Note that the volume 10 is a non-volatile volume on the node. By using hostPath, a local volume, and the like, it becomes available from the container(s) in the job.

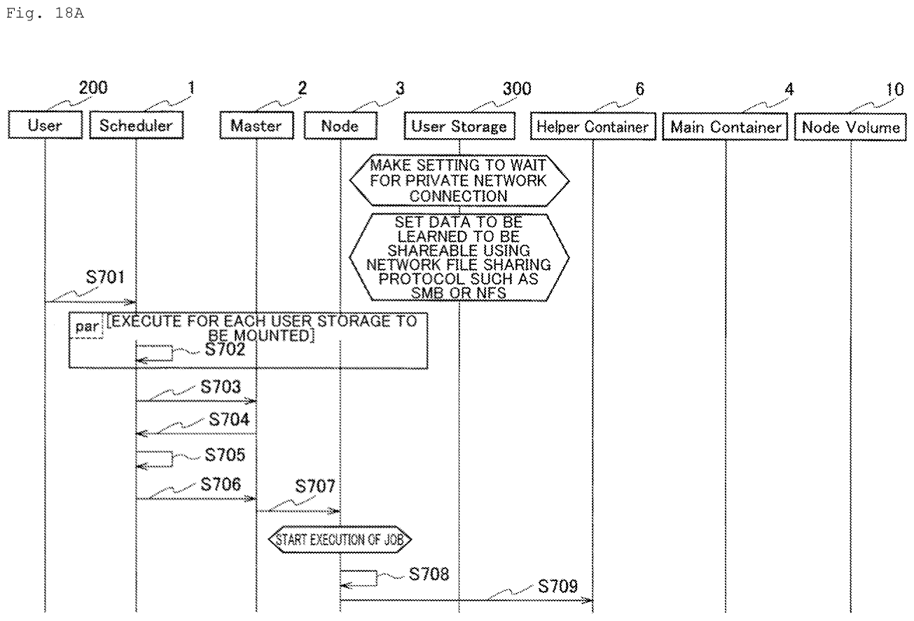

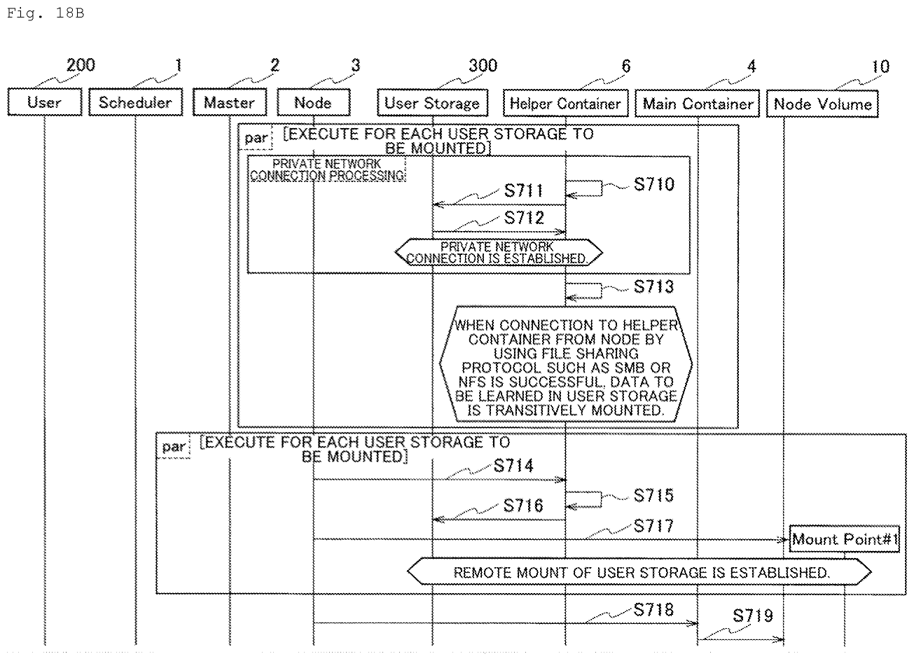

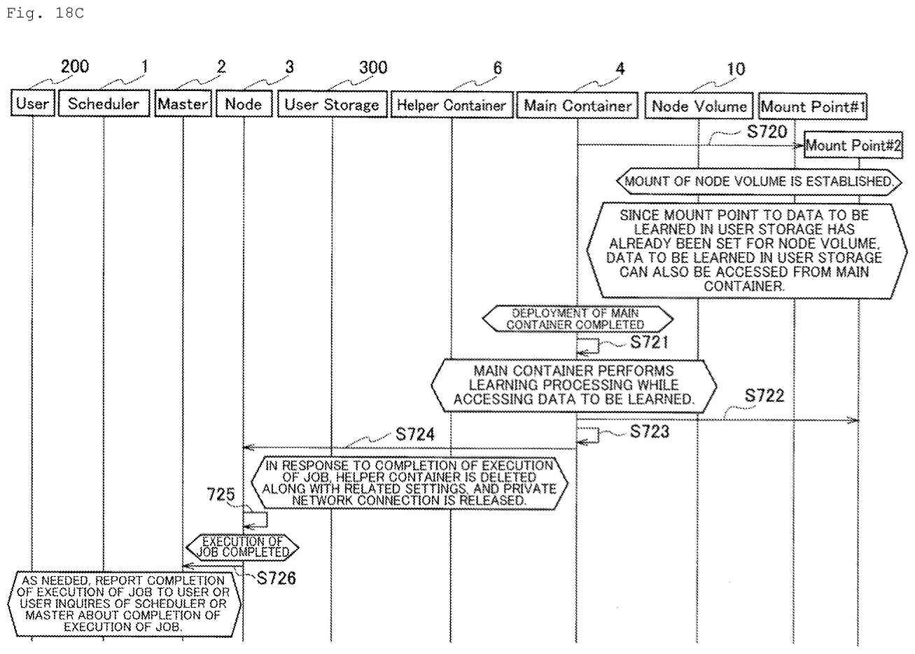

FIG. 18 is a diagram illustrating an operation sequence of the sixth job configuration pattern.

In advance, the user site storage 300 makes a setting to wait for a private network connection. Further, the user site storage 300 is set in advance so that the data to be learned can be shared by using the network file sharing protocol.

First, the user terminal 200 registers a job for a learning program to be executed in the scheduler 1 (step S701). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, based on the information on private network connection to the storage 300 and the information on access to data to be learned, the scheduler 1 creates protocol transfer information required for protocol transfer in the helper container 6 for each user site storage 300 to be mounted (step S702). Specifically, the scheduler 1 creates wait point information for waiting for the file sharing protocol or the like from the main container 4 in the helper container 6, and information for determining the information on private network connection to the storage 300 which is the transfer destination of the file sharing protocol or the like arrived at the wait point. Note that the access to the data to be learned from the main container 4 is to the wait point information created here for the helper container 6.

Next, the scheduler 1 inquires of the master 2 about the availability of GPU resources (step S703), receives a report of the availability of GPU resources from the master 2 (step S704), and then schedules the execution time for the job based on the report (step S705).

Next, the scheduler 1 instructs the master 2 to deploy the job when the job is executed (step S706). At this time, the scheduler 1 transmits the definition information on the job, the information on private network connection to the storage 300, the information on access to data to be learned, the protocol transfer information, the authentication information such as a user ID, and the like to the master 2.

Next, the master 2 deploys the job to the node 3 (step S707). At this time, the master 2 registers in the node 3 the definition information on the job, the information on private network connection to the storage 300, the information on access to data to be learned, and the protocol transfer information.

Next, based on the definition information on the job, the node 3 builds a virtual environment for the job (step S708), and creates a helper container 6 (step S709). At this time, the node 3 transmits the information on private network connection to the storage 300, the information on access to data to be learned, and the protocol transfer information to the helper container 6.

Next, based on the information on private network connection to the storage 300, the helper container 6 sets the configuration of the private network connection internally (step S710), requests the private network connection to the storage 300 (step S711), and accordingly that storage 300 accepts the private network connection (step S712). As a result, the private network connection is established between the helper container 6 and the storage 300.

Next, based on the protocol transfer information, the helper container 6 starts a protocol wait function of waiting for a file sharing protocol from the main container 4 and a protocol transfer function of performing protocol transfer via the private network connection in response to receiving the file sharing protocol (step S713). As a result, when the file sharing protocol from the node 3 is communicatively connected to the helper container 6, the data to be learned in the storage 300 is transitively mounted.

Next, the node 3 starts mounting the data to be learned in the user site storage 300 through the helper container 6 by using the file sharing protocol (step S714). The helper container 6 performs transfer processing of the file sharing protocol (step S715), and mounts the data to be learned in the storage 300 (step S716). After that, the node 3 configures mount point #1 (step S717). For example, the node 3 mounts the data to be learned in the user site storage 300 onto the node volume 10 by specifying as a mount point a directory on the node volume 10. As a result, a remote mount of the storage 300 is established.

Next, the node 3 creates a main container 4 (step S718). The main container 4 mounts the node volume 10 (step S719) and configures mount point #2 (step S720). As a result, a mount of the node volume 10 is established. Further, since mount point #1 of the data to be learned in the storage 300 has already been set in the node volume 10, the data to be learned in the storage 300 can also be accessed from the main container 4.

Next, the main container 4 starts the learning processing of the job (step S721), performs the learning processing while accessing the data to be learned, and writes the learning processing results to mount point #2 (step S722).

Next, after the learning processing is completed (step S723), the main container 4 reports the completion of execution of the main container 4 to the node 3 (step S724). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #2.

Finally, the node 3 deletes the virtual space and the like for the job (step S725), and reports the completion of execution of the job to the master 2 (step S726). After that, as needed, the master 2 reports the completion of execution of the job to the user terminal 200. Alternatively, the user terminal 200 inquires the scheduler 1 or the master 2 about the completion of execution of the job.

[Examples of Private Network Connection Methods]

Examples of the private network connection methods will be described below.

[First Private Network Connection Method]

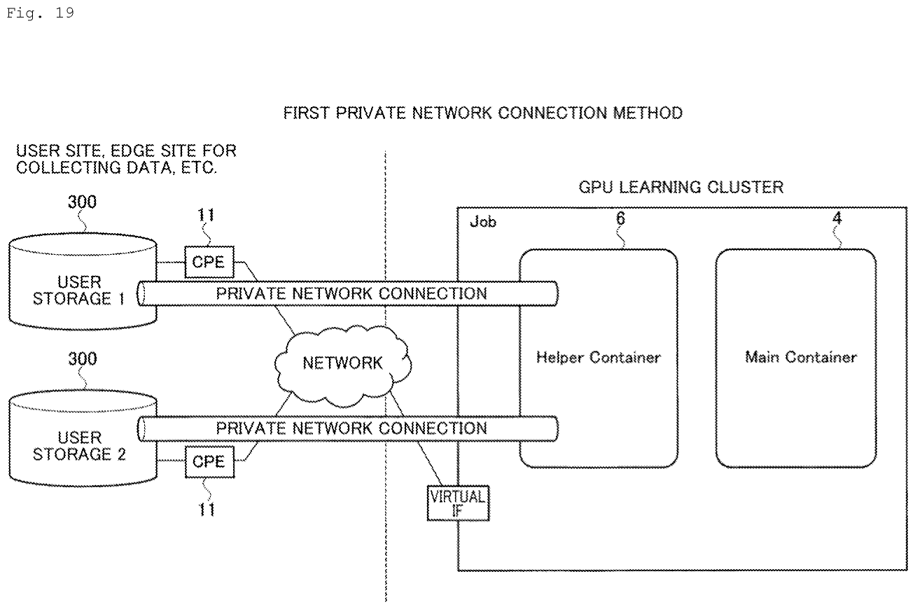

FIG. 19 is a diagram illustrating a first private network connection method.

In the first private network connection method, the user site storage 300 has a function of making a private network connection, and waits for a private network connection from the helper container 6 via a CPE (Customer Premises Equipment) 11 at the user site. When the scheduler 1 deploys a job, the helper container 6 starts a private network connection with the user site storage 300. When the execution of the job is completed, the container(s) in the job are deleted and the private network connection is also released. After that, the user site storage 300 returns to the state for waiting for a private network connection, and is always in the state of waiting for the private network connection.

Note that the user and the cluster provider of the GPU learning cluster determine in advance private network connection information required for making a private network connection. Further, the user sets in advance the configuration of the private network connection required for making the private network connection with the helper container 6 in the storage 300 of the user.

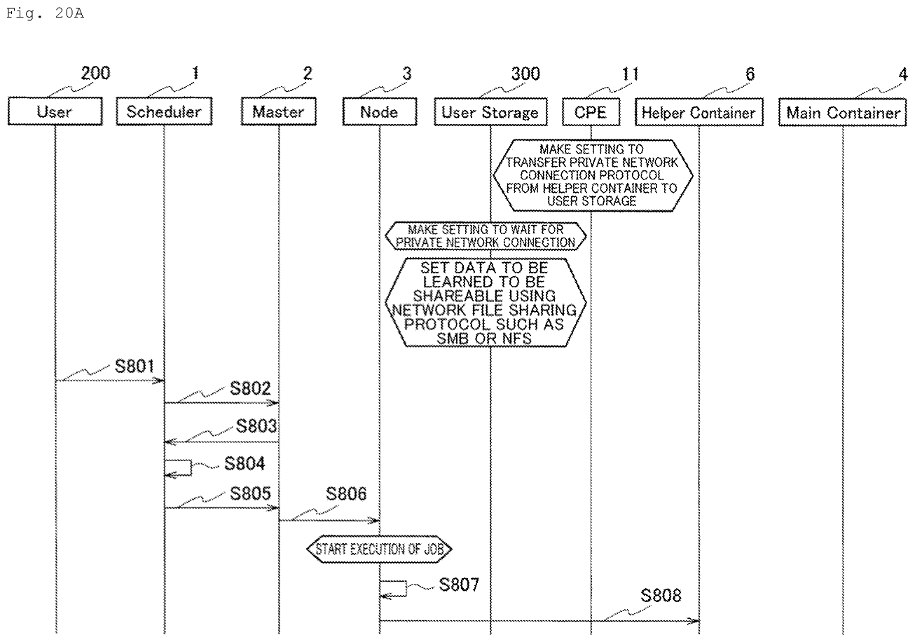

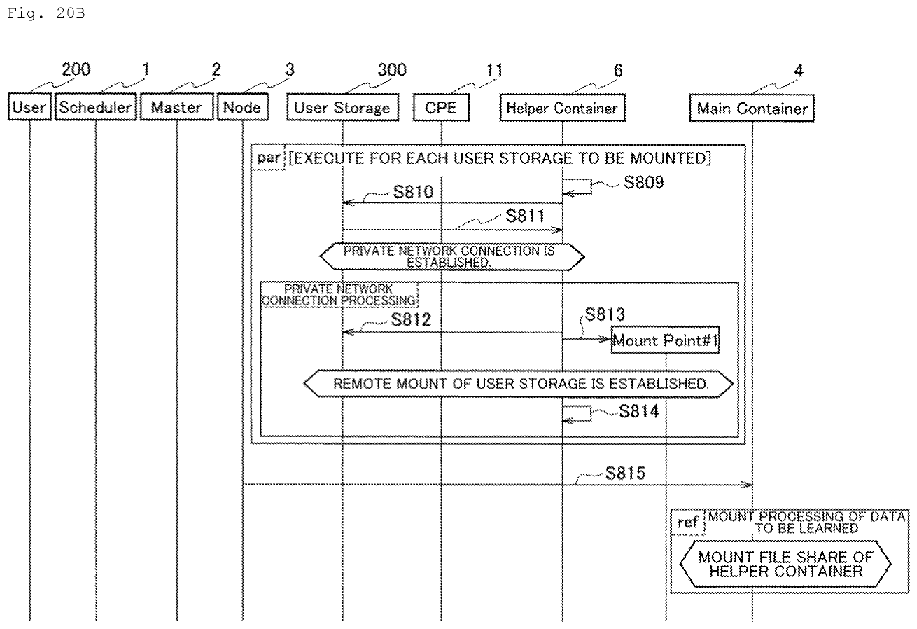

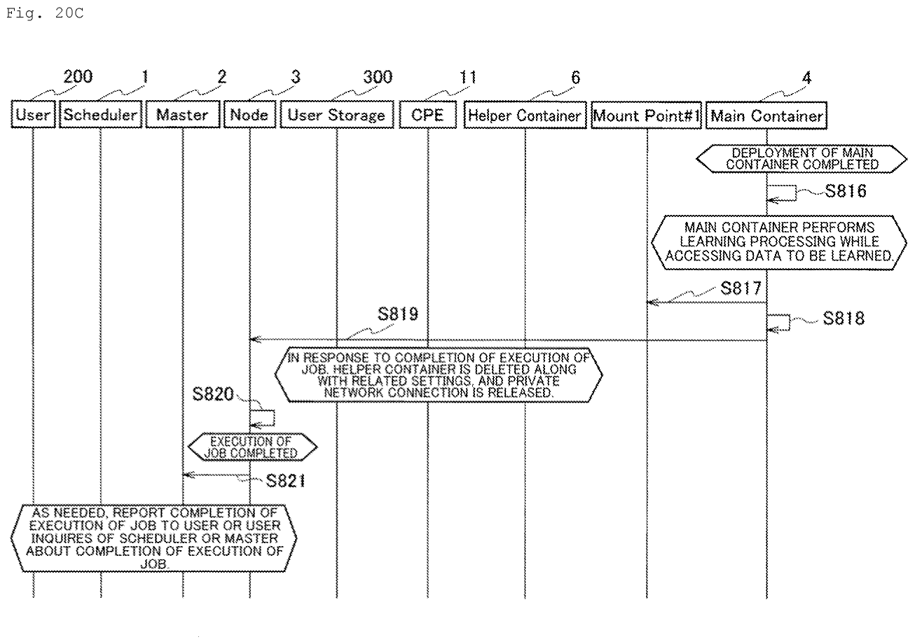

FIG. 20 is a diagram illustrating an operation sequence of the first private network connection method.

In advance, the CPE 11 makes a setting to transfer a private network connection protocol from the helper container 6 to the user site storage 300. Further, the user site storage 300 is set in advance to wait for a private network connection from the helper container 6. Further, the user site storage 300 is set in advance so that the data to be learned can be shared by using the network file sharing protocol.

First, the user terminal 200 registers a job for a learning program to be executed in the scheduler 1 (step S801). At this time, the user terminal 200 transmits definition information on the job, information on private network connection to the storage 300, information on access to data to be learned, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S802), receives a report of the availability of GPU resources from the master 2 (step S803), and then schedules the execution time for the job based on the report (step S804).

Next, the scheduler 1 instructs the master 2 to deploy the job when the job is executed (step S805). At this time, the scheduler 1 registers in the master 2 the definition information on the job, the information on private network connection to the storage 300, the information on access to data to be learned, the authentication information such as a user ID, and the like.

Next, the master 2 deploys the job to the node 3 (step S806). At this time, the master 2 transmits the definition information on the job, the information on private network connection to the storage 300, and the information on access to data to be learned to the node 3.

Next, based on the definition information on the job, the node 3 builds a virtual environment for the job (step S807), and creates a helper container 6 (step S808). At this time, the node 3 transmits the information on private network connection to the storage 300 and the information on access to data to be learned to the helper container 6.

Next, based on the information on private network connection to the storage 300, the helper container 6 sets the configuration of the private network connection internally (step S809), requests the private network connection to the storage 300 (step S810), and accordingly that storage 300 accepts the private network connection (step S811). As a result, the private network connection is established between the helper container 6 and the storage 300.

Next, based on the information on access to data to be learned, the helper container 6 mounts the data to be learned in the storage 300 by using the network file sharing protocol via the private network connection (step S812). Further, the helper container 6 configures mount point #1 (step S813). As a result, a remote mount of the storage 300 is established. After that, the helper container 6 sets mount point #1 to be in a transitive shared state (step S814). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S815).

Next, the main container 4 starts the learning processing of the job (step S816), performs the learning processing while accessing the data to be learned, and writes the learning processing results to mount point #1 (step S817).

Next, after the learning processing is completed (step S818), the main container 4 reports the completion of execution of the main container 4 to the node 3 (step S819). The completion in the main container 4 results in the completion of execution of the job. In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Finally, the node 3 deletes the virtual space and the like for the job (step S820), and reports the completion of execution of the job to the master 2 (step S821). After that, as needed, the master 2 reports the completion of execution of the job to the user terminal 200. Alternatively, the user terminal 200 inquires the scheduler 1 or the master 2 about the completion of execution of the job.

[Second Private Network Connection Method]

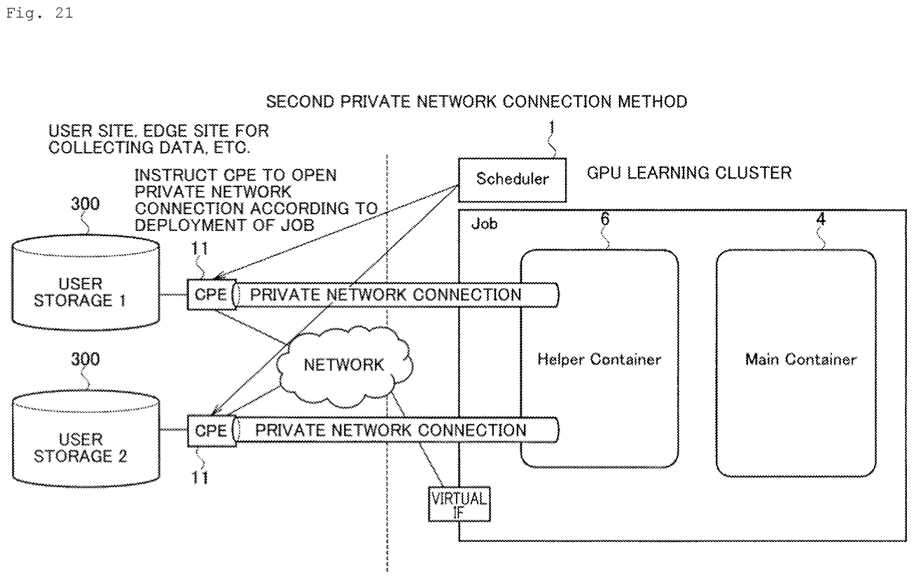

FIG. 21 is a diagram illustrating a second private network connection method.

In the second private network connection method, as the CPE 11 at the user site, a CPE is used having a VPN function and a control API (Application Programming Interface) that can be controlled by the scheduler 1. The scheduler (scheduling unit) 1 schedules the execution time for the job based on the usage of the GPU(s), and instructs the CPE 11, which terminates the communication path of the private network connection on the user site side, to open the private network connection.

For the second private network connection method, two methods will be described. A first method is a method of requesting the establishment of a private network connection from the CPE 11 side. A second method is a method of requesting the establishment of a private network connection from the helper container 6 side.

[Second Private Network Connection Method (First Method)]

In the second private network connection method (first method), a private network connection is configured on demand. Specifically, when a job is registered, information on connection to the API of the CPE 11 is included. The scheduler 1 starts the helper container 6 and sets the helper container 6 to be in the state for waiting for a private network connection. In response to receiving an instruction from the scheduler 1, the CPE 11 requests the helper container 6 which is the instructed connection destination to make a private network connection. When the private network connection is established, the helper container 6 starts the remote mount processing. When the execution of the job is completed, the container(s) in the job are deleted and the CPE 11 is requested to release the private network connection.

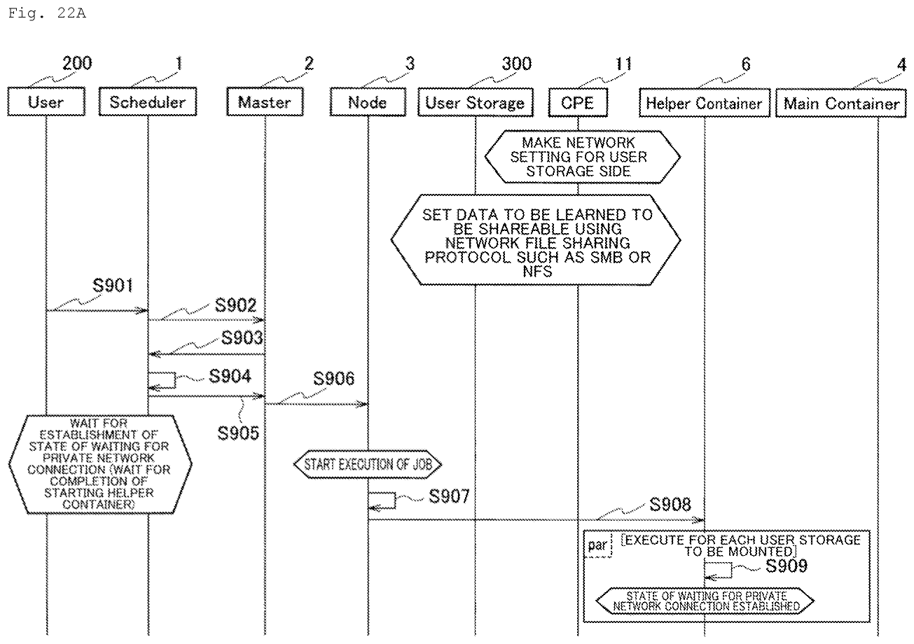

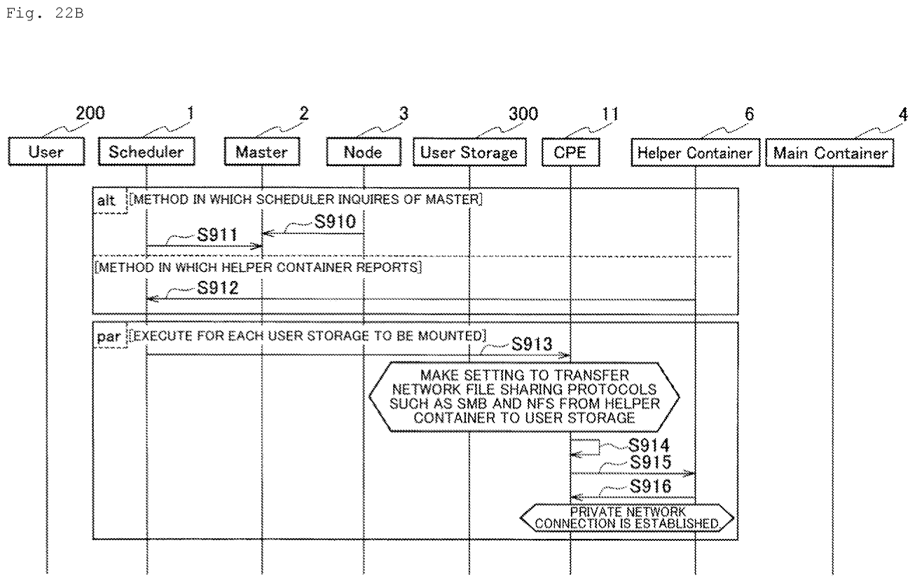

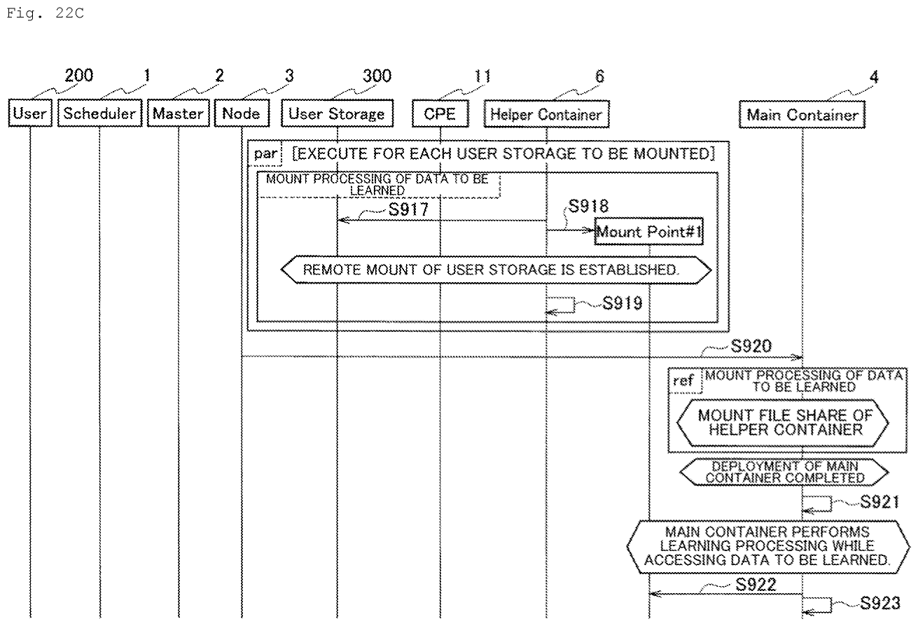

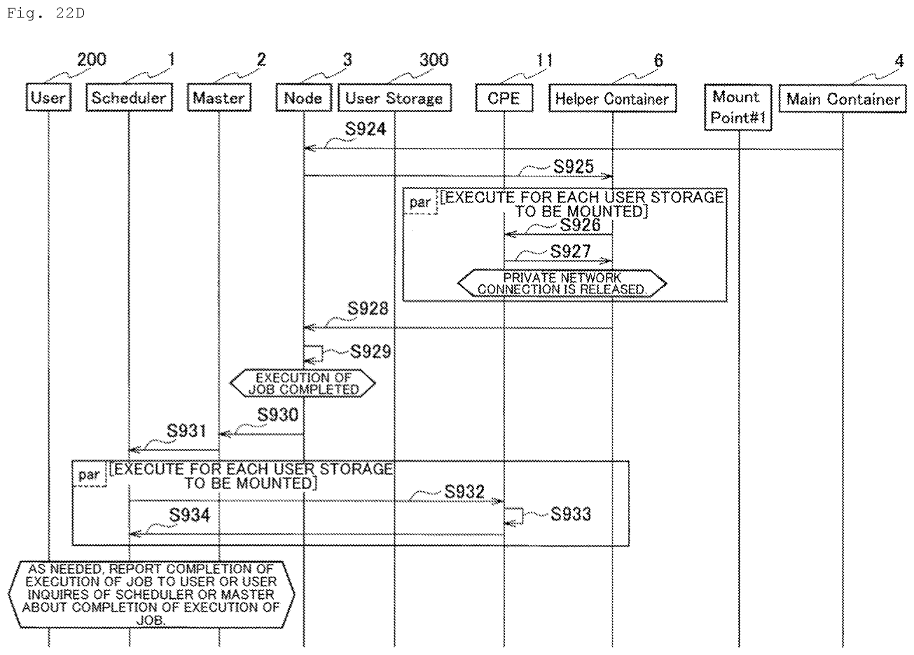

FIG. 22 is a diagram illustrating an operation sequence of the second private network connection method (first method).

In advance, the CPE 11 makes a network setting for the user site storage 300. Further, the user site storage 300 is set in advance so that the data to be learned can be shared by using the network file sharing protocol.

First, the user terminal 200 registers a job for a learning program to be executed in the scheduler 1 (step S901). At this time, the user terminal 200 transmits definition information on the job, information on private network connection to the storage 300, information on access to data to be learned, authentication information such as a user ID, information on connection to the API of the CPE 11, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S902), receives a report of the availability of GPU resources from the master 2 (step S903), and then schedules the execution time for the job based on the report (step S904).

Next, the scheduler 1 instructs the master 2 to deploy the job when the job is executed (step S905). At this time, the scheduler 1 transmits the definition information on the job, the information on private network connection to the storage 300, the information on access to data to be learned, the authentication information such as a user ID, and the like to the master 2. After that, the scheduler 1 waits for the establishment of the state of waiting for private network connection, that is, waits for completion of starting of the helper container 6.

Next, the master 2 deploys the job to the node 3 (step S906). At this time, the master 2 transmits the definition information on the job, the information on private network connection to the storage 300, and the information on access to data to be learned to the node 3.

Next, based on the definition information on the job, the node 3 builds a virtual environment for the job (step S907), and creates a helper container 6 (step S908). At this time, the node 3 transmits the information on private network connection to the storage 300 and the information on access to data to be learned to the helper container 6.

Next, based on the information on private network connection to the storage 300, the helper container 6 makes a setting to wait for a private network connection (step S909). As a result, the state of waiting for private network connection is established.

Next, for a method in which the scheduler 1 inquires of the master 2, the node 3 reports the completion of starting the helper container 6 to the master 2. This report includes information on private network connection to the helper container 6 as status information for start processing of the helper container 6 (step S910). The scheduler 1 confirms the completion of starting the helper container 6 from the master 2, and acquires the information on private network connection to the helper container 6 from the master 2 (step S911). On the other hand, for a method in which the helper container 6 reports, the helper container 6 notifies the scheduler 1 of the establishment of the state of waiting for private network connection and the information on private network connection (step S912).

Next, the scheduler 1 instructs the CPE 11 to establish the private network connection (step S913). At this time, the scheduler 1 transmits the information on private network connection to the helper container 6 to the CPE 11. As a result, the CPE 11 makes a setting to transfer a network sharing protocol from the helper container 6 to the user site storage 300.

Next, based on the information on private network connection to the helper container 6, the CPE 11 sets the configuration of the private network connection internally (step S914), and requests the helper container 6 for the private network connection (step S915), and that helper container 6 accepts the private network connection, accordingly (step S916). As a result, the private network connection is established between the CPE 11 and the helper container 6.

Next, based on the information on access to data to be learned, the helper container 6 mounts the data to be learned in the storage 300 by using the network file sharing protocol via the private network connection (step S917). Further, the helper container 6 configures mount point #1 (step S918). As a result, a remote mount of the storage 300 is established. After that, the helper container 6 sets mount point #1 to be in a transitive shared state (step S919). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S920).

Next, the main container 4 starts the learning processing of the job (step S921), performs the learning processing while accessing the data to be learned, and writes the learning processing results to mount point #1 (step S922).

Next, after the learning processing is completed (step S923), the main container 4 reports the completion of execution of the main container 4 to the node 3 (step S924). Note that there are two methods for writing the learning processing results: a method of sequentially writing and a method of writing all at the end of the learning processing. Further, the main container 4 may directly write the learning processing results to the user site storage 300 instead of mount point #1.

Next, the node 3 notifies the helper container 6 that the helper container 6 is terminated (step S925). The helper container 6 requests the CPE 11 to release the private network connection (step S926), and receives a request to release the private network connection from the CPE 11 (step S927). As a result, the private network connection is released.

Next, the helper container 6 reports the completion of termination processing of the helper container 6 to the node 3 (step S928). The node 3 deletes the virtual space and the like for the job (step S929), and reports the completion of execution of the job to the master 2 (step S930).

Next, the master 2 reports the completion of execution of the job to the scheduler 1 (step S931). The scheduler 1 instructs the CPE 11 to delete the setting for the private network connection (step S932). Based on the information on private network connection to the helper container 6, the CPE 11 deletes the setting information related to the private network connection (step S933), and reports to the scheduler 1 the completion of deletion of the setting for the private network connection (step S934). After that, as needed, the master 2 reports the completion of execution of the job to the user terminal 200. Alternatively, the user terminal 200 inquires the scheduler 1 or the master 2 about the completion of execution of the job.

[Second Private Network Connection Method (Second Method)]

In the second private network connection method (second method), a private network connection is configured on demand. Specifically, when a job is registered, information on connection to the API of the CPE 11 is included. Immediately before deploying the job, the scheduler 1 instructs the CPE 11 to start waiting for a private network connection in response to a request from the helper container 6. The scheduler 1 starts the helper container 6 so that the helper container 6 requests a private network connection to the CPE 11. When the private network connection is established, the helper container 6 starts the remote mount processing. When the execution of the job is completed, the container(s) in the job are deleted and the CPE 11 is requested to release the private network connection.

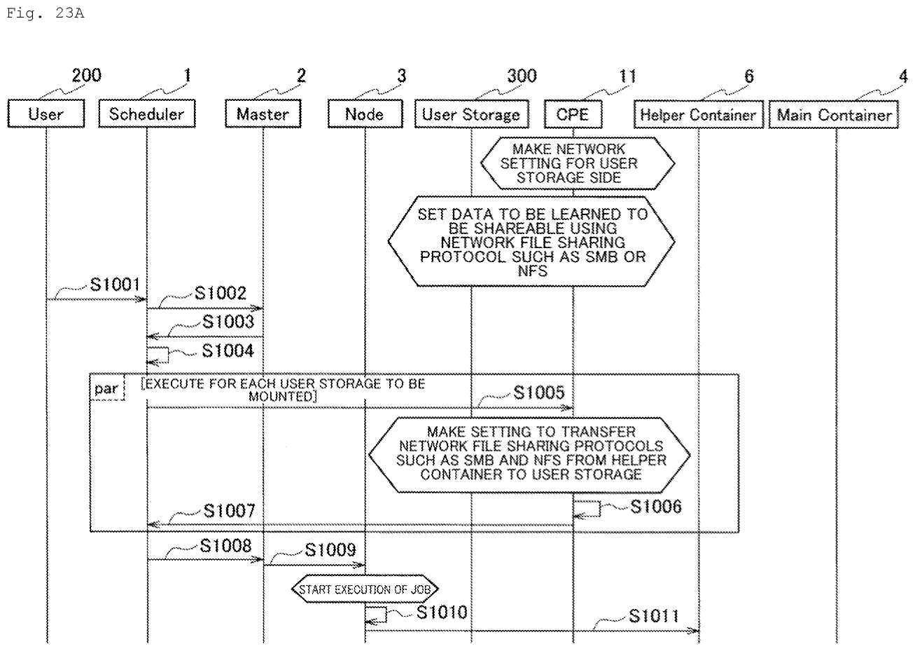

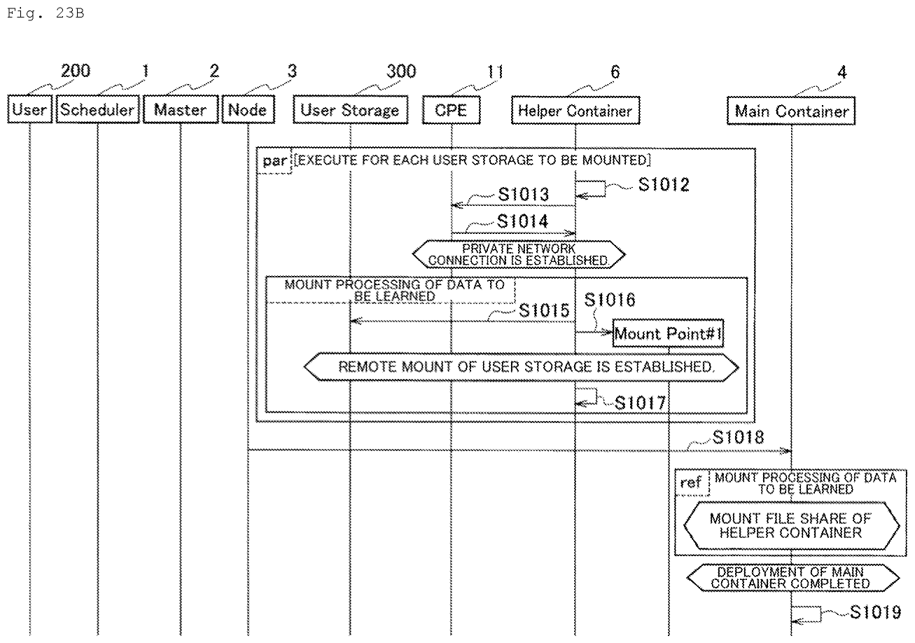

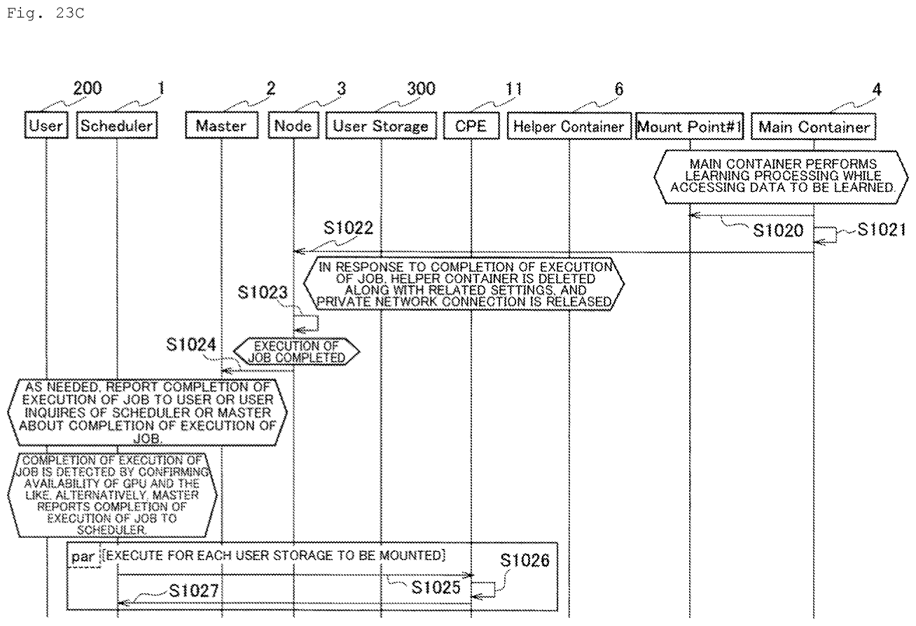

FIG. 23 is a diagram illustrating an operation sequence of the second private network connection method (second method).

In advance, the CPE 11 makes a network setting for the user site storage 300. Further, the user site storage 300 is set in advance so that the data to be learned can be shared by using the network file sharing protocol.

First, the user terminal 200 registers a job for a learning program to be executed in the scheduler 1 (step S1001). At this time, the user terminal 200 transmits definition information on the job, information on private network connection to the storage 300, information on access to data to be learned, authentication information such as a user ID, information on connection to the API of the CPE 11, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S1002), receives a report of the availability of GPU resources from the master 2 (step S1003), and then schedules the execution time for the job based on the report (step S1004).

Next, the scheduler 1 instructs the CPE 11 to start waiting for a private network connection (step S1005). The CPE 11 makes a setting to transfer the network sharing protocol from the helper container 6 to the user site storage 300 and a setting to wait for a private network connection (step S1006), and reports to the scheduler 1 the start of waiting for a private network connection (step S1007).

Next, the scheduler 1 instructs the master 2 to deploy the job when the job is executed (step S1008). At this time, the scheduler 1 transmits the definition information on the job, the information on private network connection to the storage 300, the information on access to data to be learned, the authentication information such as a user ID, and the like to the master 2.

Next, the master 2 deploys the job to the node 3 (step S1009). At this time, the master 2 transmits the definition information on the job, the information on private network connection to the storage 300, and the information on access to data to be learned to the node 3.

Next, based on the definition information on the job, the node 3 builds a virtual environment for the job (step S1010), and creates a helper container 6 (step S1011). At this time, the node 3 transmits the information on private network connection to the storage 300 and the information on access to data to be learned to the helper container 6.

Next, the helper container 6 sets the configuration of the private network connection internally based on the information on private network connection to the helper container 6 (step S1012) and requests the CPE 11 for the private network connection (step S1013), and that CPE 11 accepts the private network connection, accordingly (step S1014). As a result, the private network connection is established between the helper container 6 and the CPE 11.

Next, based on the information on access to data to be learned, the helper container 6 mounts the data to be learned in the storage 300 by using the network file sharing protocol via the private network connection (step S1015). Further, the helper container 6 configures mount point #1 (step S1016). As a result, a remote mount of the storage 300 is established. After that, the helper container 6 sets mount point #1 to be in a transitive shared state (step S1017). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S1018).

Next, the main container 4 starts the learning processing of the job (step S1019), performs the learning processing while accessing the data to be learned, and writes the learning processing results to mount point #1 (step S1020).

Next, after the learning processing is completed (step S1021), the main container 4 reports the completion of execution of the main container 4 to the node 3 (step S1022). In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Next, the node 3 deletes the virtual space and the like for the job (step S1023), and reports the completion of execution of the job to the master 2 (step S1024). After that, as needed, the master 2 reports the completion of execution of the job to the user terminal 200. Alternatively, the user terminal 200 inquires the scheduler 1 or the master 2 about the completion of execution of the job. Further, the scheduler 1 detects the completion of execution of the job by confirming the availability of the GPU and the like. Alternatively, the master 2 reports the completion of execution of the job to the scheduler 1.

Finally, the scheduler 1 instructs the CPE 11 to delete the setting for the private network connection (step S1025). Based on the information on private network connection to the helper container 6, the CPE 11 deletes the setting information related to the private network connection (step S1026), and reports to the scheduler 1 the completion of deletion of the setting for the private network connection (step S1027).

[Third Private Network Connection Method]

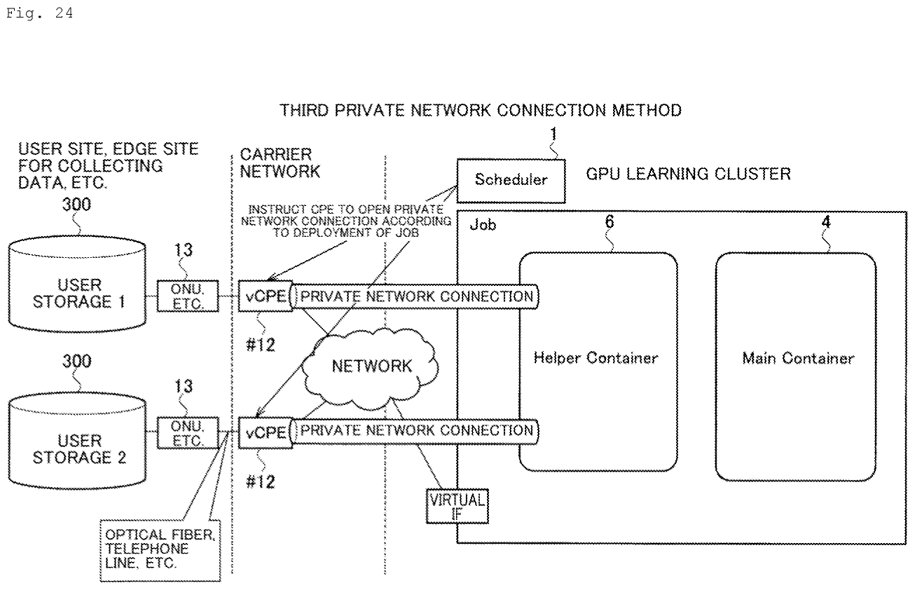

FIG. 24 is a diagram illustrating a third private network connection method.

In the third private network connection method, a virtualized vCPE (virtual Customer Premises Equipment) 12, which includes a VPN function and a control API to be controlled from the scheduler 1 is installed in a carrier network. Alternatively, a vCPE 12 installed in the carrier network is used. Only an ONU (Optical Network Unit) 13 and a modem is installed at the user site, and the ONU 13 and the vCPE 12 are connected by Layer 2 of the OSI reference model such as Ethernet.

The scheduler (scheduling unit) 1 schedules the execution time for the job based on the usage of the GPU(s), and instructs the vCPE 12, which terminates the communication path of the private network connection in the carrier network, to open the private network connection.

Also for the third private network connection method, two methods will be described. A first method is a method of requesting the establishment of a private network connection from the vCPE 12 side. A second method is a method of requesting the establishment of a private network connection from the helper container 6 side.

[Third Private Network Connection Method (First Method)]

In the third private network connection method (first method), a private network connection is configured on demand. Specifically, when a job is registered, line identification information for identifying the line of the carrier network to which the user site storage 300 is connected is included. The scheduler 1 starts the helper container 6 and sets the helper container 6 to be in the state for waiting for a private network connection. In response to receiving an instruction from the scheduler 1, the vCPE 12 requests the helper container 6 which is the instructed connection destination to make a private network connection. When the private network connection is established, the helper container 6 starts the remote mount processing. When the execution of the job is completed, the vCPE 12 is requested to release the private network connection before the container(s) in the job are deleted.

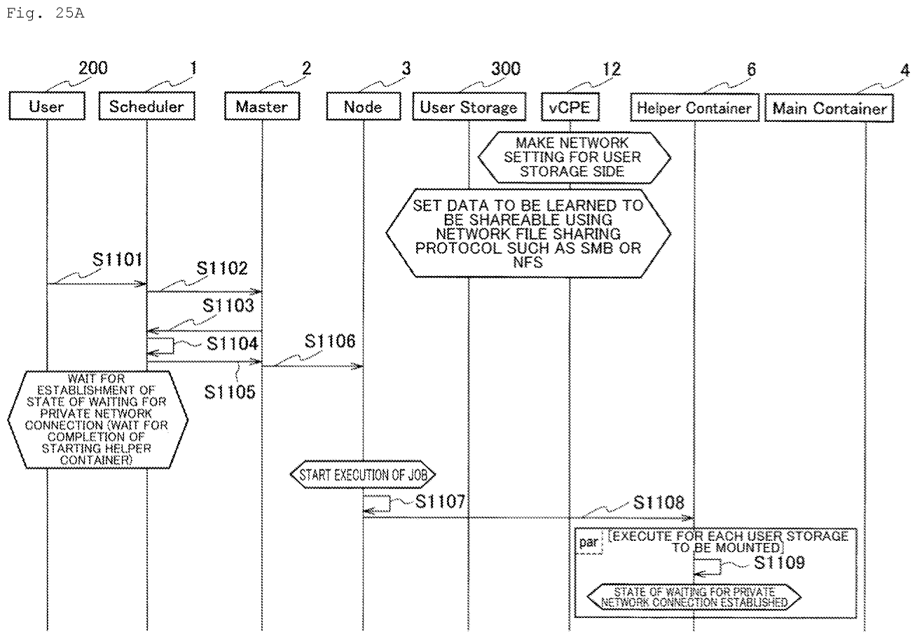

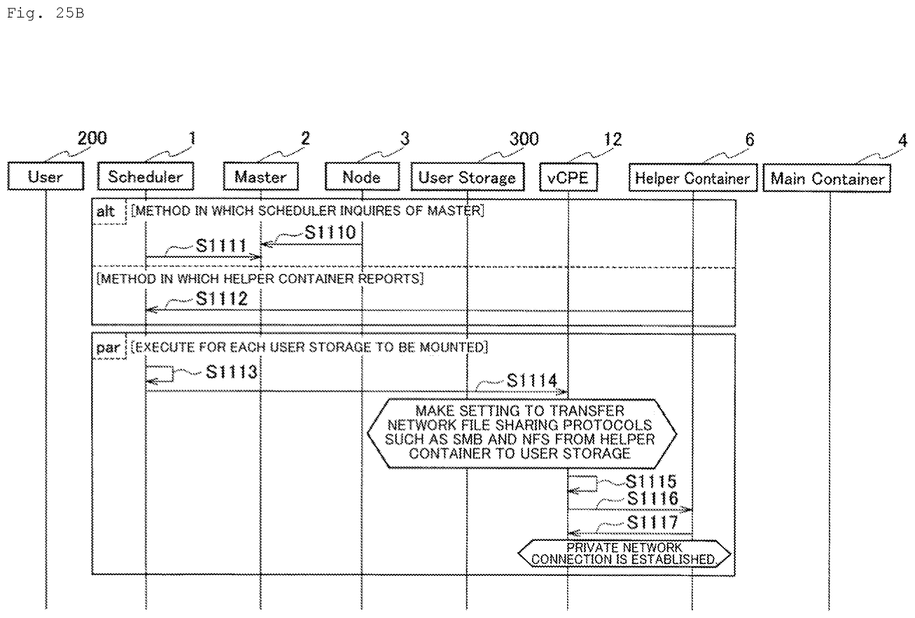

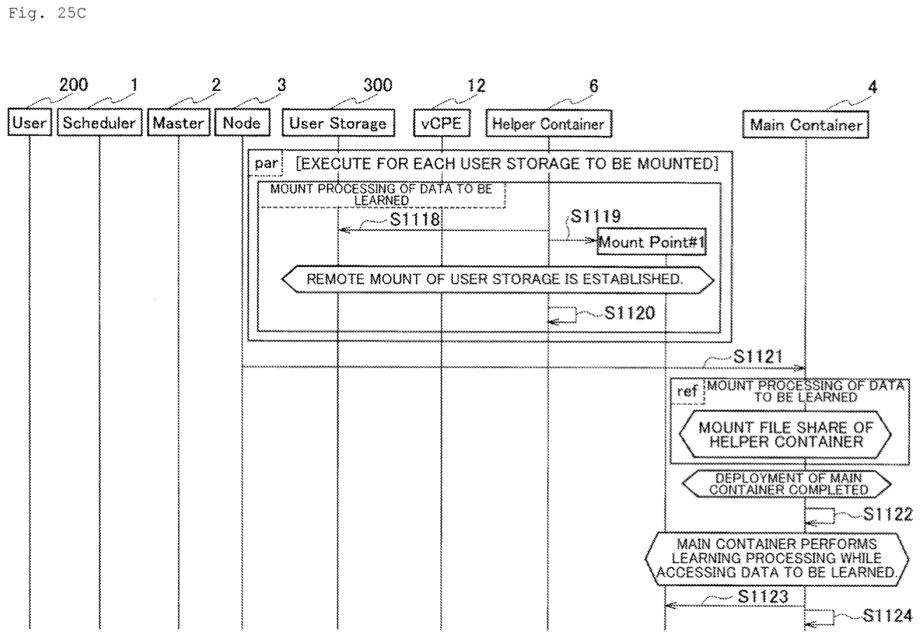

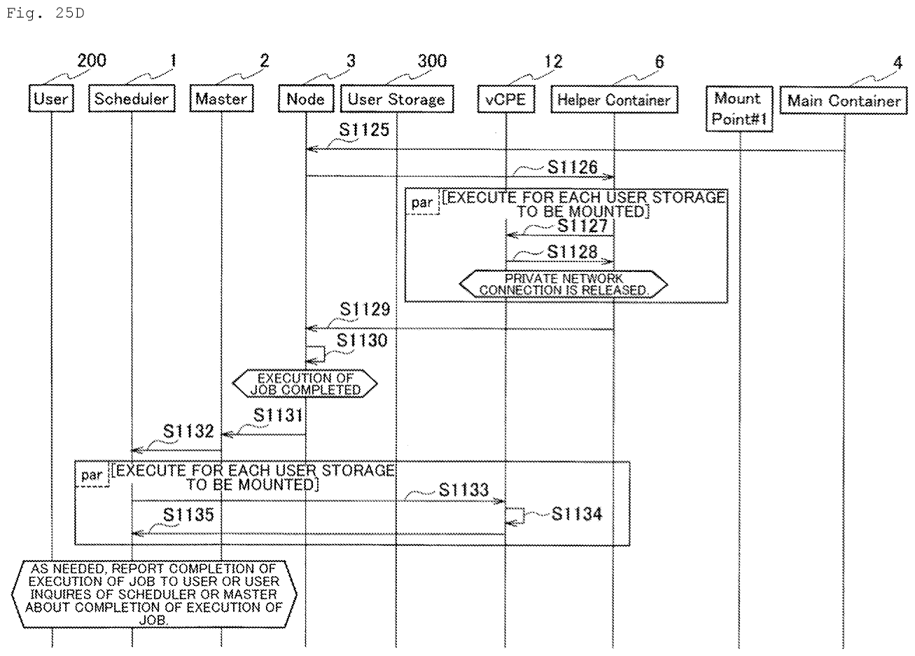

FIG. 25 is a diagram illustrating an operation sequence of the third private network connection method (first method).

In advance, the vCPE 12 makes a network setting for the user site storage 300. Further, the user site storage 300 is set in advance so that the data to be learned can be shared by using the network file sharing protocol.

First, the user terminal 200 registers a job for a learning program to be executed in the scheduler 1 (step S1101). At this time, the user terminal 200 transmits definition information on the job, information on private network connection to the storage 300, information on access to data to be learned, line identification information, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S1102), receives a report of the availability of GPU resources from the master 2 (step S1103), and then schedules the execution time for the job based on the report (step S1104).

Next, the scheduler 1 instructs the master 2 to deploy the job when the job is executed (step S1105). At this time, the scheduler 1 transmits the definition information on the job, the information on private network connection to the storage 300, the information on access to data to be learned, the authentication information such as a user ID, and the like to the master 2. After that, the scheduler 1 waits for the establishment of the state of waiting for private network connection, that is, waits for completion of starting of the helper container 6.

Next, the master 2 deploys the job to the node 3 (step S1106). At this time, the master 2 transmits the definition information on the job, the information on private network connection to the storage 300, and the information on access to data to be learned to the node 3.

Next, based on the definition information on the job, the node 3 builds a virtual environment for the job (step S1107), and creates a helper container 6 (step S1108). At this time, the node 3 transmits the information on private network connection to the storage 300 and the information on access to data to be learned to the helper container 6.

Next, based on the information on private network connection to the storage 300, the helper container 6 makes a setting to wait for a private network connection (step S1109). As a result, the state of waiting for private network connection is established.

Next, for a method in which the scheduler 1 inquires of the master 2, the node 3 reports the completion of starting of the helper container 6 to the master 2 (step S1110), and the scheduler 1 confirms the completion of starting of the helper container 6 by the master 2, and then acquires the information on waiting for private network connection from the master 2 (step S1111). On the other hand, for a method in which the helper container 6 reports, the helper container 6 notifies the scheduler 1 of the establishment of the state of waiting for private network connection and the information on waiting for private network connection (step S1112).

Next, based on the line identification information, the scheduler 1 acquires information on connection to the API of the vCPE 12 from a carrier DB in the carrier network (step S1113). Then, based on the information on connection to the API of the vCPE 12, the scheduler 1 instructs the vCPE 12 to establish a private network connection (step S1114). At this time, the scheduler 1 transmits the information on private network connection to the helper container 6 to the vCPE 12. As a result, the vCPE 12 makes a setting to transfer a network sharing protocol from the helper container 6 to the user site storage 300.

Next, based on the information on private network connection to the helper container 6, the vCPE 12 sets the configuration of the private network connection internally (step S1115) and requests the helper container 6 for the private network connection (step S1116), and that helper container 6 accepts the private network connection, accordingly (step S1117). As a result, the private network connection is established between the vCPE 12 and the helper container 6.

Next, the helper container 6 starts the mount processing of the data to be learned in response to the establishment of the private network connection. Based on the information on access to data to be learned, the helper container 6 mounts the data to be learned in the storage 300 by using the network file sharing protocol via the private network connection (step S1118). Further, the helper container 6 configures mount point #1 (step S1119). As a result, a remote mount of the storage 300 is established. After that, the helper container 6 sets mount point #1 to be in a transitive shared state (step S1120). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S1121).

Next, the main container 4 starts the learning processing of the job (step S1122), performs the learning processing while accessing the data to be learned, and writes the learning processing results to mount point #1 (step S1123).

Next, after the learning processing is completed (step S1124), the main container 4 reports the completion of execution of the main container 4 to the node 3 (step S1125). Note that there are two methods for writing the learning processing results: a method of sequentially writing and a method of writing all at the end of the learning processing. The main container 4 may directly write the learning processing results to the user site storage 300 instead of mount point #1.

Next, the node 3 notifies the helper container 6 that the helper container 6 is terminated (step S1126). The helper container 6 requests the vCPE 12 to release the private network connection (step S1127), and receives a request to release the private network connection from the vCPE 12 (step S1128). As a result, the private network connection is released.

Next, the helper container 6 reports the completion of termination processing of the helper container 6 to the node 3 (step S1129). The node 3 deletes the virtual space and the like for the job (step S1130), and reports the completion of execution of the job to the master 2 (step S1131).

Next, the master 2 reports the completion of execution of the job to the scheduler 1 (step S1132). The scheduler 1 instructs vCPE 12 to delete the setting for the private network connection (step S1133). Based on the information on private network connection to the helper container 6, the vCPE 12 deletes the setting information related to the private network connection (step S1134), and reports to the scheduler 1 the completion of deletion of the setting for the private network connection (step S1135). After that, as needed, the master 2 reports the completion of execution of the job to the user terminal 200. Alternatively, the user terminal 200 inquires the scheduler 1 or the master 2 about the completion of execution of the job.

[Third Private Network Connection Method (Second Method)]

In the third private network connection method (second method), a private network connection is configured on demand. Specifically, when a job is registered, line identification information for identifying the line of the carrier network to which the user site storage 300 is connected is included. Immediately before deploying the job, the scheduler 1 instructs the vCPE 12 to start waiting for a private network connection in response to a request from the helper container 6. The scheduler 1 starts the helper container 6 so that the helper container 6 requests a private network connection to the vCPE 12. When the private network connection is established, the helper container 6 starts the remote mount processing. When the execution of the job is completed, the vCPE 12 is requested to release the private network connection before the container(s) in the job are deleted.

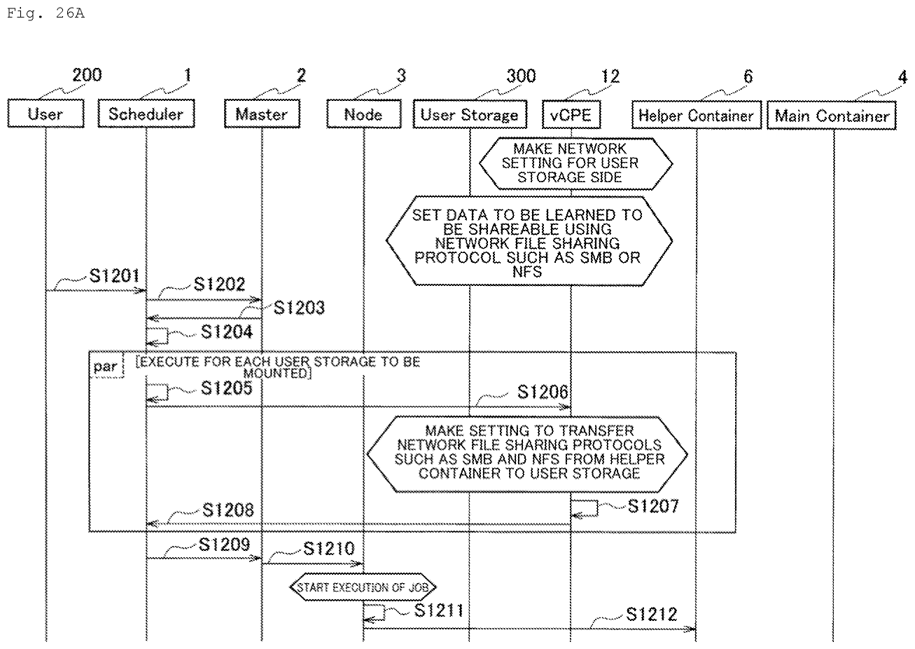

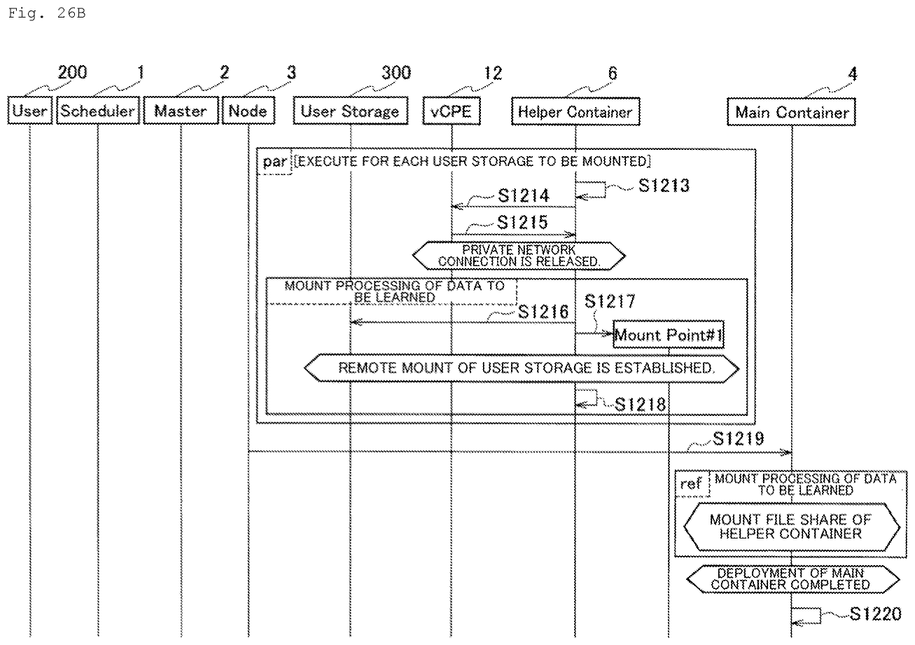

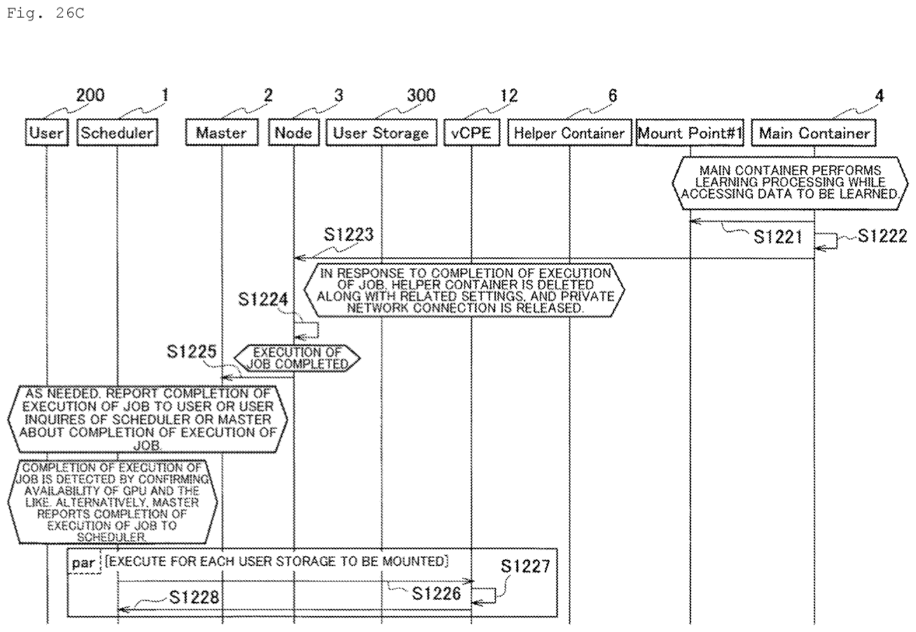

FIG. 26 is a diagram illustrating an operation sequence of the third private network connection method (second method).

In advance, the vCPE 12 makes a network setting for the user site storage 300. Further, the user site storage 300 is set in advance so that the data to be learned can be shared by using the network file sharing protocol.

First, the user terminal 200 registers a job for a learning program to be executed in the scheduler 1 (step S1201). At this time, the user terminal 200 transmits definition information on the job, information on private network connection to the storage 300, information on access to data to be learned, line identification information, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S1202), receives a report of the availability of GPU resources from the master 2 (step S1203), and then schedules the execution time for the job based on the report (step S1204).

Next, based on the line identification information, the scheduler 1 acquires information on connection to the API of the vCPE 12 from a carrier DB in the carrier network (step S1205). Then, based on the information on connection to the API of the vCPE 12, the scheduler 1 instructs the vCPE 12 to start waiting for a private network connection (step S1206). The vCPE 12 makes a setting to transfer the network sharing protocol from the helper container 6 to the user site storage 300 and a setting to wait for a private network connection (step S1207), and reports to the scheduler 1 the start of waiting for a private network connection (step S1208).

Next, the scheduler 1 instructs the master 2 to deploy the job when the job is executed (step S1209). At this time, the scheduler 1 transmits the definition information on the job, the information on private network connection to the storage 300, the information on access to data to be learned, the authentication information such as a user ID, and the like to the master 2.

Next, the master 2 deploys the job to the node 3 (step S1210). At this time, the master 2 transmits the definition information on the job, the information on private network connection to the storage 300, and the information on access to data to be learned to the node 3.

Next, based on the definition information on the job, the node 3 builds a virtual environment for the job (step S1211), and creates a helper container 6 (step S1212). At this time, the node 3 transmits the information on private network connection to the storage 300 and the information on access to data to be learned to the helper container 6.

Next, based on the information on private network connection to the helper container 6, the helper container 6 sets the configuration of the private network connection internally (step S1213), and requests the vCPE 12 for the private network connection (step S1214), and that vCPE 12 accepts the private network connection, accordingly (step S1215). As a result, the private network connection is established between the helper container 6 and the vCPE 12.

Next, based on the information on access to data to be learned, the helper container 6 mounts the data to be learned in the storage 300 by using the network file sharing protocol via the private network connection (step S1216). Further, the helper container 6 configures mount point #1 (step S1217). As a result, a remote mount of the storage 300 is established. After that, the helper container 6 sets mount point #1 to be in a transitive shared state (step S1218). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S1219).

Next, the main container 4 starts the learning processing of the job (step S1220), performs the learning processing while accessing the data to be learned, and writes the learning processing results to mount point #1 (step S1221).

Next, after the learning processing is completed (step S1222), the main container 4 reports the completion of execution of the main container 4 to the node 3 (step S1223). In response to the completion of execution of the job, the helper container 6 is deleted along with related settings, and the private network connection is released. Note that there are two methods for writing the learning processing results: a method of sequentially writing and a method of writing all at the end of the learning processing. Further, the main container 4 may directly write the learning processing results to the user site storage 300 instead of mount point #1.

Next, the node 3 deletes the virtual space and the like for the job (step S1224), and reports the completion of execution of the job to the master 2 (step S1225). After that, as needed, the master 2 reports the completion of execution of the job to the user terminal 200. Alternatively, the user terminal 200 inquires the scheduler 1 or the master 2 about the completion of execution of the job. Further, the scheduler 1 detects the completion of execution of the job by confirming the availability of the GPU and the like. Alternatively, the master 2 reports the completion of execution of the job to the scheduler 1.

Finally, the scheduler 1 instructs the vCPE 12 to delete the setting for the private network connection (step S1226). Based on the information on private network connection to the helper container 6, the vCPE 12 deletes the setting information related to the private network connection (step S1227), and reports to the scheduler 1 the completion of deletion of the setting for the private network connection (step S1228).

[Fourth Private Network Connection Method]

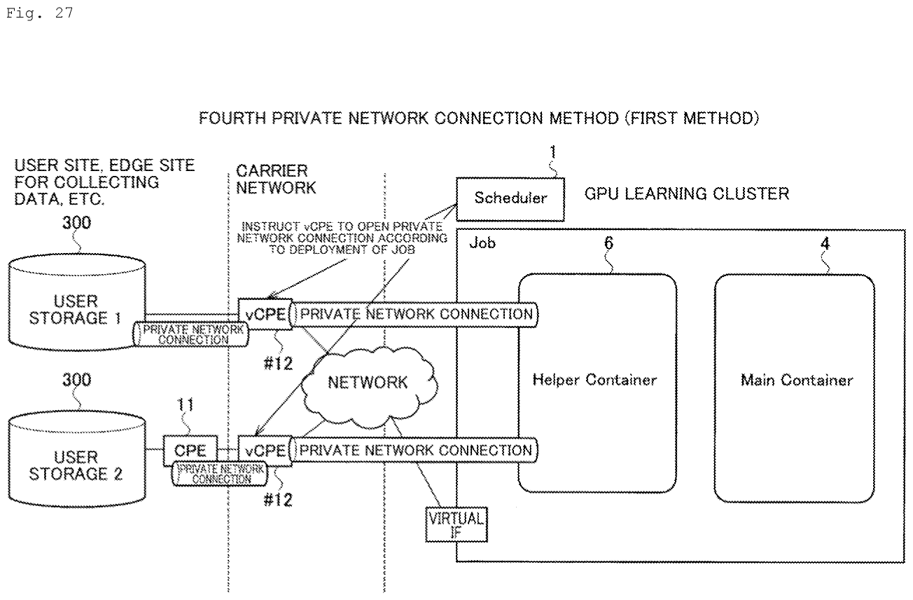

FIG. 27 is a diagram illustrating a fourth private network connection method (first method).

In the fourth private network connection method (first method), a virtualized vCPE 12 including a VPN function and a control API to be controlled from the scheduler 1 and the helper container 6 is installed in the carrier network. Alternatively, a vCPE 12 installed in the carrier network is used. The vCPE 12 is connected to the user site storage 300 or is connected to the user site CPE 11.

The scheduler (scheduling unit) 1 schedules the execution time for the job based on the usage of the GPU(s), and instructs the CPE 11, which terminates the communication path of the private network connection at the user site, and the vCPE 12, which terminates the communication path in the carrier network, to open the private network connection.

Also for the fourth private network connection method, two methods will be described. In both of the two methods, the scheduler 1 gives the vCPE 12 in the carrier network an instruction for a private network connection. In the first method, the user terminal 200 gives the user site storage 300 or CPE 11 an instruction for a private network connection. In the second method, the scheduler 1 also gives the user site storage 300 or CPE 11 an instruction for a private network connection.

Note that, in both the first method and the second method, the establishment of the private network connection is requested from the helper container 6, but each method is applicable as a method in which the establishment of the private network connection is requested from the vCPE 12 as in the first method of the second private network connection method and the third private network connection method.

[Fourth Private Network Connection Method (First Method)]

In the fourth private network connection method (first method), a private network connection is configured on demand. Specifically, immediately before deploying the job, the scheduler 1 instructs the vCPE 12 to start waiting for a private network connection in response to a request from the helper container 6 and the user site storage 300 or CPE 11. The scheduler 1 starts the helper container 6 so that the helper container 6 requests a private network connection to the vCPE 12. The user terminal 200 sets the storage 300 or the CPE 11 for a private network connection to the vCPE 12. When the private network connection is established, the helper container 6 starts the remote mount processing. When the execution of the job is completed, the vCPE 12 is requested to release the private network connection.

Note that as an instance of a vCPE 12, for example, an instance corresponding to a vCPE 12 closest to the user site among previously deployed instances pooled is assigned when the job is deployed. In addition, an instance of the vCPE 12 may also be deployed when the job is deployed. Further, although it is assumed that there is a vCPE 12 for each user site storage 300, a plurality of vCPEs 12 may be shared by one vCPE 12.

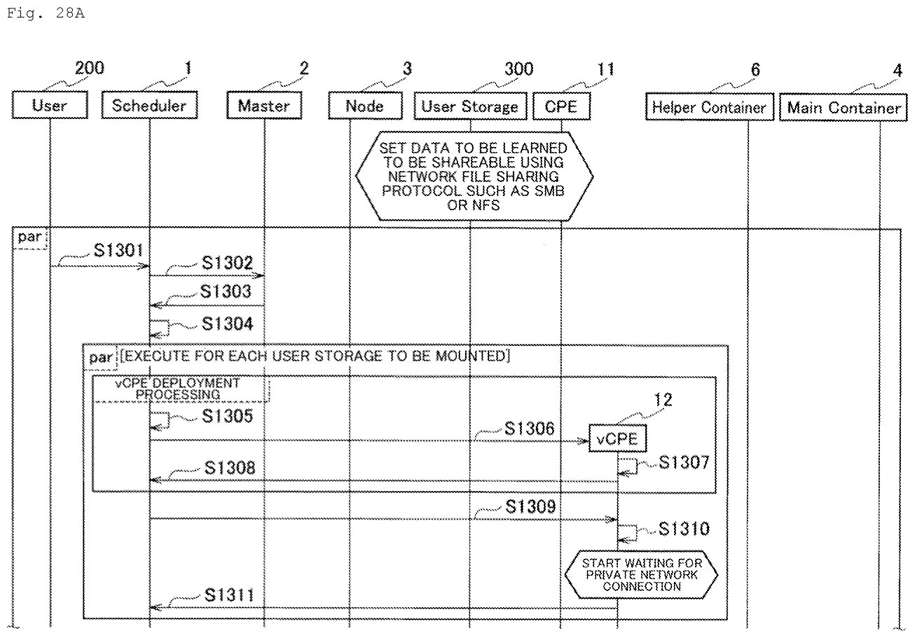

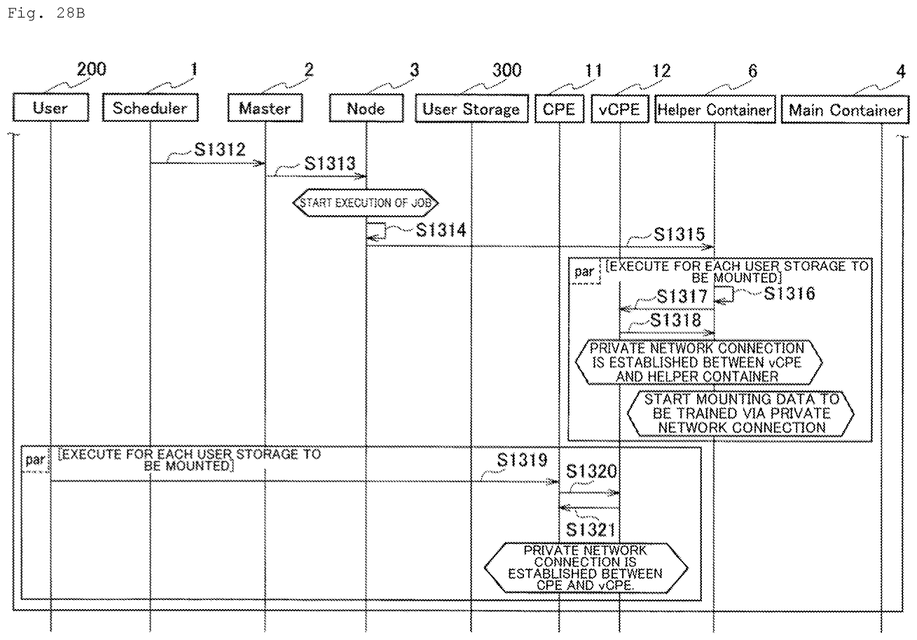

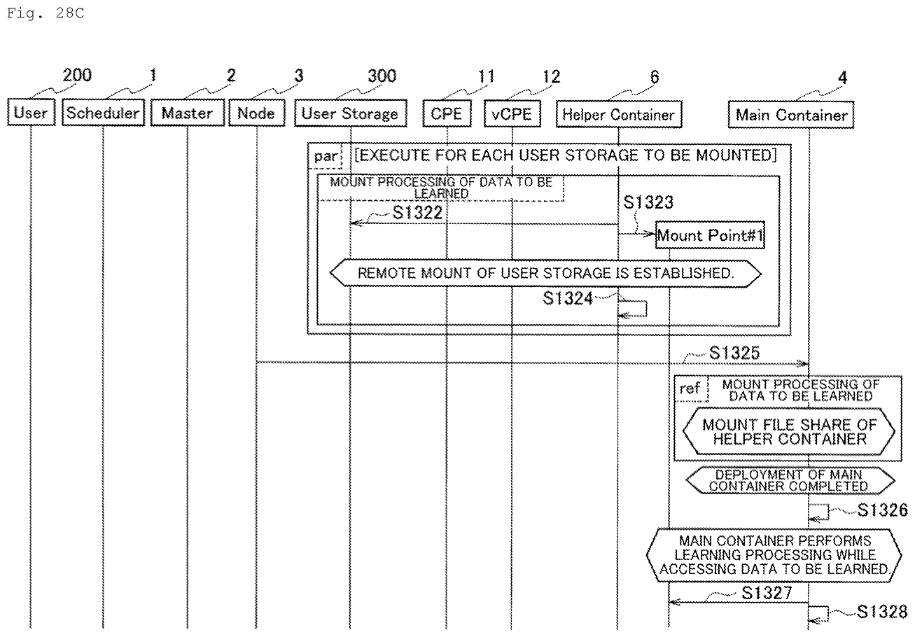

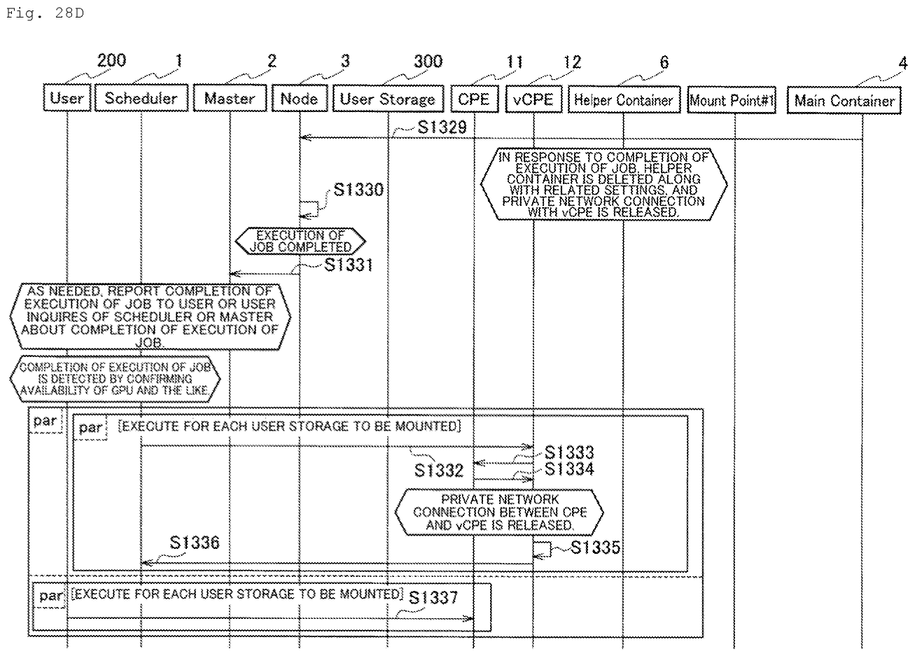

FIG. 28 is a diagram illustrating an operation sequence of the fourth private network connection method (first method).

The user site storage 300 is set in advance so that the data to be learned can be shared by using the network file sharing protocol.

First, the user terminal 200 registers a job for a learning program to be executed in the scheduler 1 (step S1301). At this time, the user terminal 200 transmits definition information on the job, information on private network connection to the storage 300, information on access to data to be learned, line identification information, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S1302), receives a report of the availability of GPU resources from the master 2 (step S1303), and then schedules the execution time for the job based on the report (step S1304).

Next, based on the line identification information, the scheduler 1 determines a site where a vCPE 12 is deployed (step S1305), and deploys the vCPE 12 (step S1306). At this time, the scheduler 1 registers, in the vCPE 12, line identification information and information on private network connection to the storage 300. The vCPE 12 makes a setting for the network and the like (step S1307), and reports the completion of the deployment to the scheduler 1 (step S1308).

Note that the deployment processing of a vCPE 12 may be performed by a request to the carrier network infrastructure. In that case, the request is made using the line identification information and vCPE requirements. Further, the deployment processing of a vCPE 12 may be performed in a manner that a vCPE 12 closest to the user site is assigned from a pool of vCPEs 12 previously deployed, and the vCPE 12 is set based on line identification information, instead of each time the job is registered.

Next, the scheduler 1 instructs the vCPE 12 to start waiting for a private network connection (step S1309). The vCPE 12 makes a setting to wait for a private network connection (step S1310), starts waiting for a private network connection request in response to a request from the helper container 6 and the user site storage 300 or CPE 11, and reports the start of waiting for a private network connection to the scheduler 1. At this time, the information on private network connection to the vCPE 12 is notified to the scheduler 1 (step S1311).

Next, the scheduler 1 instructs the master 2 to deploy the job when the job is executed (step S1312). At this time, the scheduler 1 transmits the definition information on the job, the information on private network connection to the vCPE 12, the information on access to data to be learned, the authentication information such as a user ID, and the like to the master 2.

Next, the master 2 deploys the job to the node 3 (step S1313). At this time, the master 2 transmits the definition information on the job, the information on private network connection to the vCPE 12, and the information on access to data to be learned to the node 3.

Next, based on the definition information on the job, the node 3 builds a virtual environment for the job (step S1314), and creates a helper container 6 (step S1315). At this time, the node 3 transmits the information on private network connection to the vCPE 12 and the information on access to data to be learned to the helper container 6.

Next, based on the information on private network connection to the vCPE 12, the helper container 6 sets the configuration of the private network connection internally (step S1316), and requests the vCPE 12 for the private network connection (step S1317), and that vCPE 12 accepts the private network connection, accordingly (step S1318).

As a result, the private network connection is established between the helper container 6 and the vCPE 12. The helper container 6 will start mounting the data to be learned via the private network connection. Note that, although mounting of the data to be learned is started later, the data to be learned can be mounted only after a private network connection is established between the CPE 11 or the user site storage 300 and the vCPE 12. Accordingly, a request for connection using a file mount sharing protocol is repeatedly retransmitted. Then, after the private network connection is established between the CPE 11 or the user site storage 300 and the vCPE 12 so that the data to be learned can be mounted, the mount processing of the data to be learned is continuously executed.

Next, the user terminal 200 sets the CPE 11 for the private network connection (step S1319). The CPE 11 requests the vCPE 12 to start a private network connection (step S1320), the vCPE 12 accepts the private network connection (step S1321), and then the private network connection is established between the CPE 11 and the vCPE 12.

Next, based on the information on access to data to be learned, the helper container 6 mounts the data to be learned in the storage 300 by using the network file sharing protocol via the private network connection (step S1322). Further, the helper container 6 configures mount point #1 (step S1323). As a result, a remote mount of the storage 300 is established. After that, the helper container 6 sets mount point #1 to be in a transitive shared state (step S1324). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S1325).

Next, the main container 4 starts the learning processing of the job (step S1326), performs the learning processing while accessing the data to be learned, and writes the learning processing results to mount point #1 (step S1327).

Next, after the learning processing is completed (step S1328), the main container 4 reports the completion of execution of the main container 4 to the node 3 (step S1329). In response to the completion of execution of the job, the helper container 6 is deleted along with related settings, and the private network connection with the vCPE 12 is released. Note that there are two methods for writing the learning processing results: a method of sequentially writing and a method of writing all at the end of the learning processing. Further, the main container 4 may directly write the learning processing results to the user site storage 300 instead of mount point #1.

Next, the node 3 deletes the virtual space and the like for the job (step S1330), and reports the completion of execution of the job to the master 2 (step S1331). After that, as needed, the master 2 reports the completion of execution of the job to the user terminal 200. Alternatively, the user terminal 200 inquires the scheduler 1 or the master 2 about the completion of execution of the job. Further, the scheduler 1 detects the completion of execution of the job by confirming the availability of the GPU and the like.

Next, the scheduler 1 instructs the vCPE 12 to delete the setting for the private network connection (step S1332). The vCPE 12 starts deleting the setting for the private network connection with the CPE 11 (step S1333), accepts, from the CPE 11, deletion of the setting for the private network connection (step S1334), and then deletes the setting information on the private network connection (step S1335). After that, the vCPE 12 reports to the scheduler 1 the completion of deletion of the setting for the private network connection (step S1336).

Note that the private network connection between the vCPE 12 and the helper container 6 is released when the execution of the job is completed. Further, when a private network connection has been established between the user site storage 300 and the vCPE 12, the processing of deleting the setting for the private network connection is performed between the storage 300 and the vCPE 12.

Finally, the user terminal 200 deletes the setting information on the private network connection from the CPE 11 (step S1337).

[Fourth Private Network Connection Method (Second Method)]

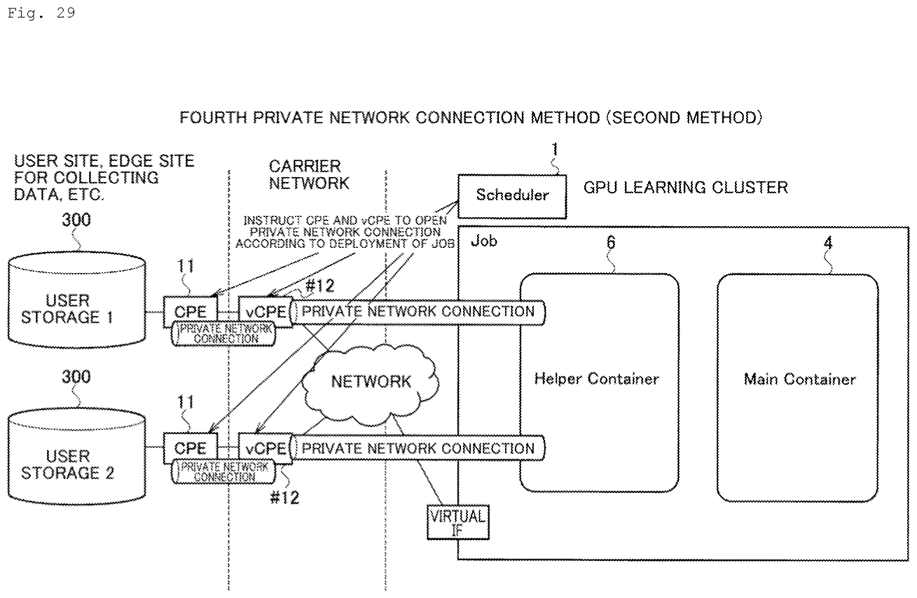

FIG. 29 is a diagram illustrating a fourth private network connection method (second method). The second method is similar to the first method illustrated in FIG. 27, except that each vCPE 12 is connected to the corresponding user site CPE 11.

In the fourth private network connection method (second method), a private network connection is configured on demand. Specifically, immediately before deploying the job, the scheduler 1 instructs the vCPE 12 to start waiting for a private network connection in response to a request from the helper container 6 and the CPE 11. The scheduler 1 starts the helper container 6 so that the helper container 6 requests a private network connection to the vCPE 12. Further, the scheduler 1 sets the CPE 11 for a private network connection to the vCPE 12. When the private network connection is established, the helper container 6 starts the remote mount processing. When the execution of the job is completed, the CPE 11 and the vCPE 12 are requested to release the private network connection. The pattern for creating an instance of the vCPE 12 is the same as that of the first method.

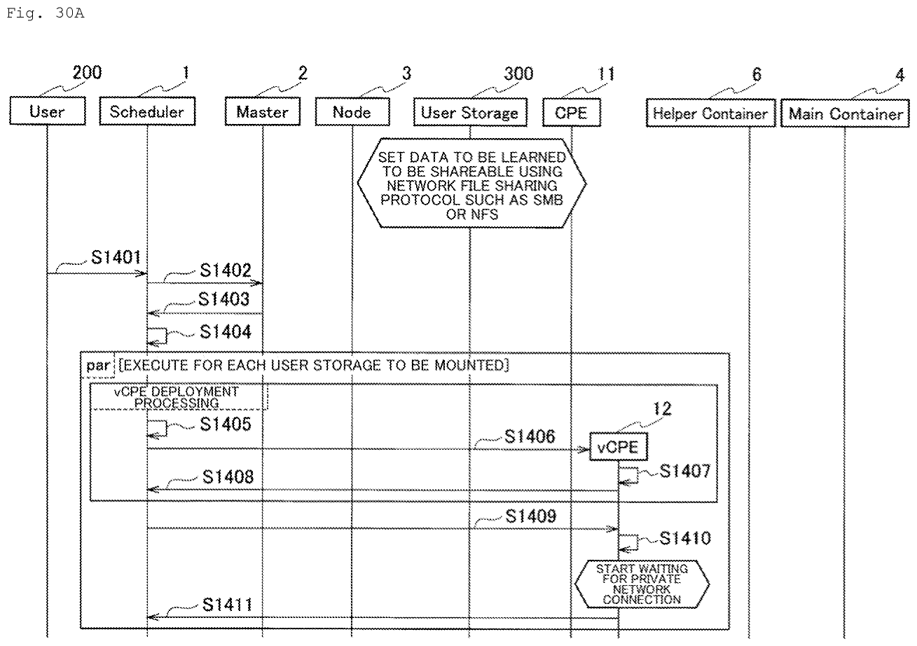

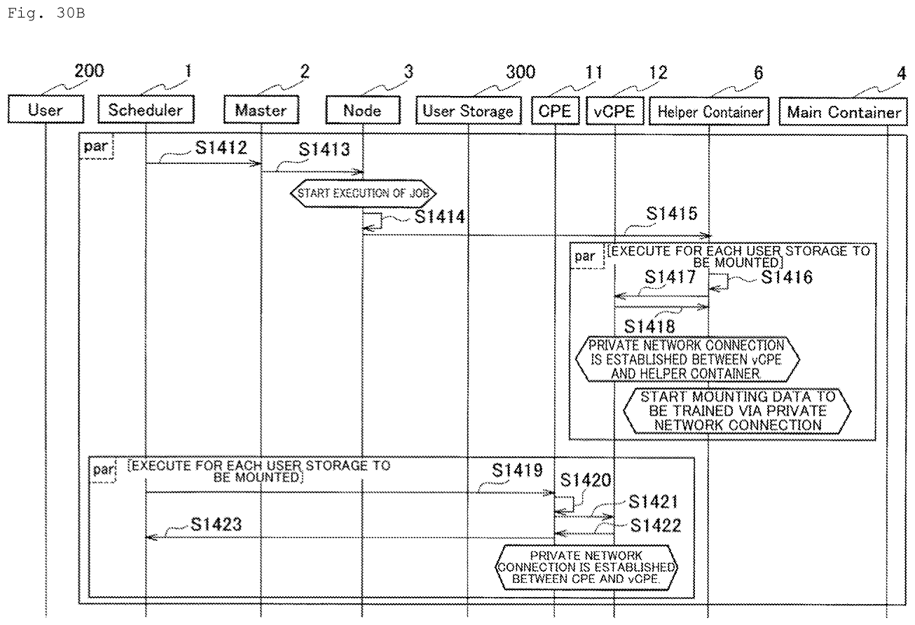

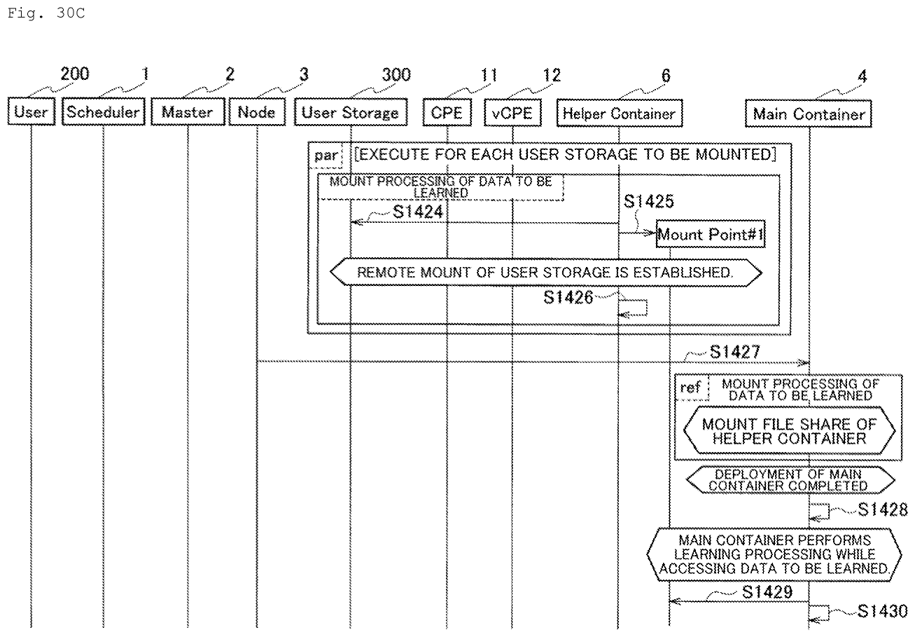

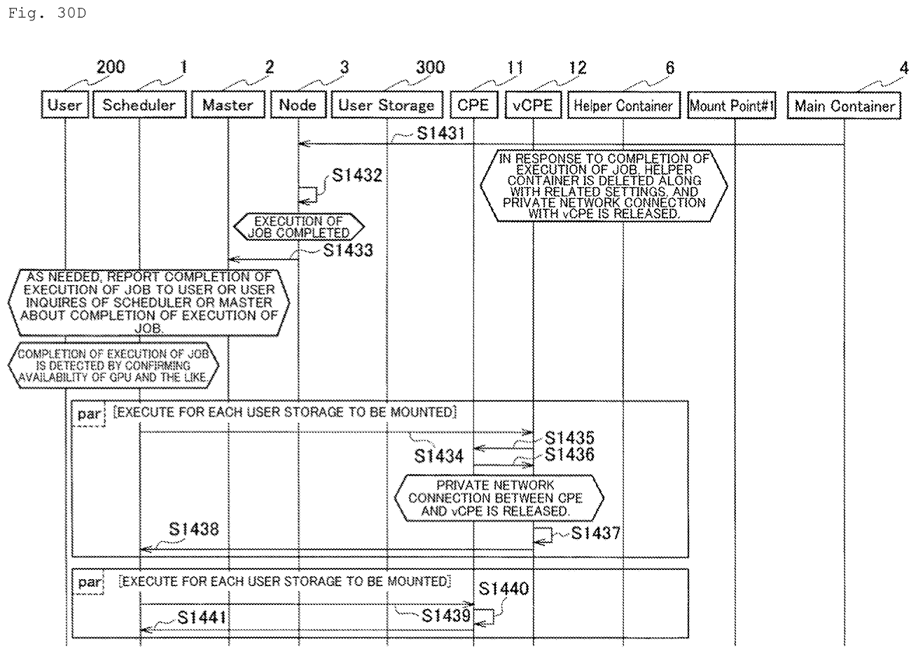

FIG. 30 is a diagram illustrating an operation sequence of the fourth private network connection method (second method).

The user site storage 300 is set in advance so that the data to be learned can be shared by using the network file sharing protocol.

First, the user terminal 200 registers a job for a learning program to be executed in the scheduler 1 (step S1401). At this time, the user terminal 200 registers, in the scheduler 1, definition information on the job, information on private network connection to the CPE 11, information on access to data to be learned, line identification information, authentication information such as a user ID, information on connection to the API of the CPE 11, and the like (step S1401). After authentication processing or the like is completed between the user terminal 200 and the scheduler 1, it proceeds to the subsequent processing.

Next, the scheduler 1 inquires of the master 2 about the availability of GPU resources (step S1402), receives a report of the availability of GPU resources from the master 2 (step S1403), and then schedules the execution time for the job based on the report (step S1404).

Next, based on the line identification information, the scheduler 1 determines a site where a vCPE 12 is deployed (step S1405), and deploys the vCPE 12 (step S1406). At this time, the scheduler 1 registers, in the vCPE 12, line identification information and information on private network connection to the CPE 11 (step S1406). The vCPE 12 makes a setting for the network and the like (step S1407), and reports the completion of the deployment to the scheduler 1 (step S1408).

Note that the deployment processing of a vCPE 12 may be performed by a request to the carrier network infrastructure. In that case, the request is made using the line identification information and vCPE requirements. Further, the deployment processing of a vCPE 12 may be performed in a manner that a vCPE 12 closest to the user site is assigned from a pool of vCPEs 12 previously deployed, and the vCPE 12 is set based on line identification information, instead of each time the job is registered.

Next, the scheduler 1 instructs the vCPE 12 to start waiting for a private network connection (step S1409). The vCPE 12 makes a setting to wait for a private network connection (step S1410), starts waiting for a private network connection request in response to a request from the helper container 6 and the CPE 11, and reports the start of waiting for a private network connection to the scheduler 1 (step S1411). At this time, information on connection to the vCPE 12 is created and notified to the scheduler 1.

Next, the scheduler 1 instructs the master 2 to deploy the job when the job is executed (step S1412). At this time, the scheduler 1 transmits the definition information on the job, the information on private network connection to the vCPE 12, the information on access to data to be learned, the authentication information such as a user ID, and the like to the master 2.

Next, the master 2 deploys the job to the node 3 (step S1413). At this time, the master 2 registers, in the node 3, the definition information on the job, the information on private network connection to the vCPE 12, and the information on access to data to be learned.

Next, based on the definition information on the job, the node 3 builds a virtual environment for the job (step S1414), and creates a helper container 6 (step S1415). At this time, the node 3 transmits the information on private network connection to the vCPE 12 and the information on access to data to be learned to the helper container 6.

Next, based on the information on private network connection to the vCPE 12, the helper container 6 makes a setting for a private network connection (step S1416), and requests the vCPE 12 for the private network connection (step S1417), and that vCPE 12 accepts the private network connection, accordingly (step S1418).

As a result, the private network connection is established between the helper container 6 and the vCPE 12. The helper container 6 will start mounting the data to be learned via the private network connection. Note that, although mounting of the data to be learned is started later, the data to be learned can be mounted only after a private network connection is established between the CPE 11 and the vCPE 12. Therefore, the file mount sharing protocol is retransmitted. Then, after the private network connection is established between the CPE 11 and the vCPE 12 so that the data to be learned can be mounted, the mount processing of the data to be learned is continuously executed.

Next, the scheduler 1 instructs the CPE 11 to start a private network connection, and registers, in the CPE 11, information on private network connection to the vCPE 12 (step S1419). Based on the information on private network connection to the vCPE 12, the CPE 11 sets the configuration of the private network connection internally (step S1420), and requests the vCPE 12 for the private network connection (step S1421), and that vCPE 12 accepts the private network connection, accordingly (step S1422). After that, the CPE 11 reports the establishment of the private network connection to the scheduler 1 (step S1423). As a result, the private network connection is established between the CPE 11 and the vCPE 12. Note that, in the processing of starting the private network connection, the signal for the private network connection is repeatedly transmitted until the private network connection is accepted.

Next, based on the information on access to data to be learned, the helper container 6 mounts the data to be learned in the storage 300 by using the network file sharing protocol via the private network connection (step S1424). Further, the helper container 6 configures mount point #1 (step S1425). As a result, a remote mount of the storage 300 is established. After that, the helper container 6 sets mount point #1 to be in a transitive shared state (step S1426). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S1427).

Next, the main container 4 starts the learning processing of the job (step S1428), performs the learning processing while accessing the data to be learned, and writes the learning processing results to mount point #1 (step S1429). Then, after the learning processing is completed (step S1430), the main container 4 reports the completion of execution of the main container 4 to the node 3 (step S1431). In response to the completion of execution of the job, the helper container 6 is deleted along with related settings, and the private network connection with the vCPE 12 is released. Note that there are two methods for writing the learning processing results: a method of sequentially writing and a method of writing all at the end of the learning processing. Further, the main container 4 may directly write the learning processing results to the user site storage 300 instead of mount point #1.

Next, the node 3 deletes the virtual space and the like for the job (step S1432), and reports the completion of execution of the job to the master 2 (step S1433). After that, as needed, the master 2 reports the completion of execution of the job to the user terminal 200. Alternatively, the user terminal 200 inquires the scheduler 1 or the master 2 about the completion of execution of the job. Further, the scheduler 1 detects the completion of execution of the job by confirming the availability of the GPU and the like.

Next, the scheduler 1 instructs the vCPE 12 to delete the setting for the private network connection (step S1434). The vCPE 12 starts deleting the setting for the private network connection with the CPE 11 (step S1435), accepts, from the CPE 11, deletion of the setting for the private network connection (step S1436), and then deletes the setting information on the private network connection (step S1437). After that, the vCPE 12 reports to the scheduler 1 the completion of deletion of the setting for the private network connection (step S1438). Note that the private network connection between the vCPE 12 and the helper container 6 is released when the execution of the job is completed.

Finally, the scheduler 1 instructs the CPE 11 to delete the setting for the private network connection (step S1439). The CPE 11 deletes the setting information on the private network connection (step S1440), and reports to the scheduler 1 the completion of deletion of the setting for the private network connection (step S1441).

[Fifth Private Network Connection Method]

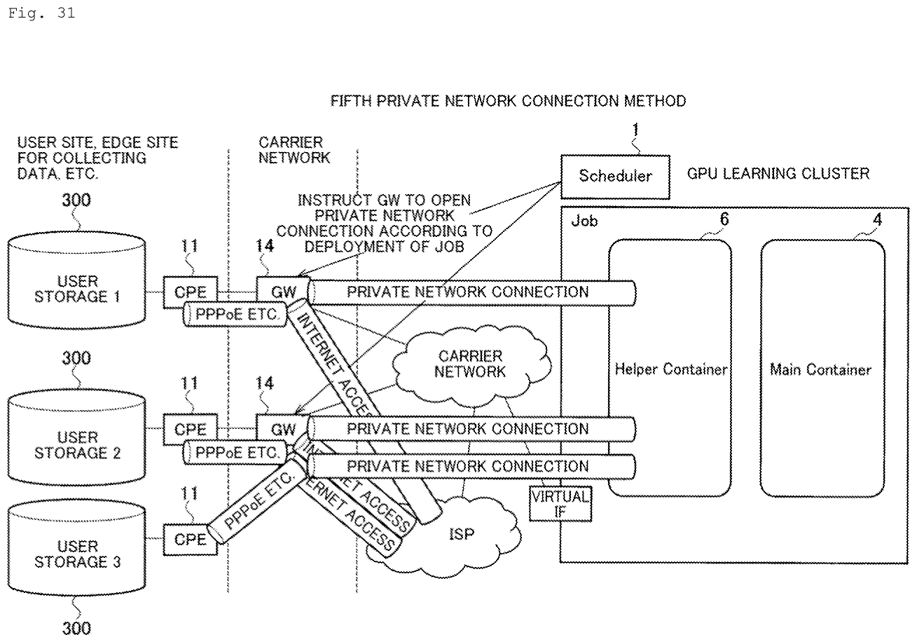

FIG. 31 is a diagram illustrating a fifth private network connection method.

In the fifth private network connection method, a private network connection function of making a private network connection with the helper container 6 and a control API to be controlled from the outside are added to a GW (Gateway) 13 that relays PPPoE or the like to the ISP (Internet Services Provider) in the carrier network.

The scheduler (scheduling unit) 1 schedules the execution time for the job based on the usage of the GPU(s), and instructs the GW 14, which terminates the communication path of the private network connection in the carrier network, to open the private network connection.

Normally, for an Internet access, a tunneling protocol such as PPPoE or DS-lite is used to connect to the ISP via the GW 14 in the carrier network. The CPE 11 is a device that terminates the tunneling protocol on the user side, and in most cases, is always connected to the GW 14 over a private network. Thus, in the fifth private network connection method, a private network connection is established between the GW 14 and the helper container 6, and the GW 14 relays the communication between the user site storage 300 and the helper container 6. Communications to other than the helper container 6 are transferred to the tunnel to the ISP as usual.

In the fifth private network connection method, a private network connection is configured on demand. Specifically, immediately before deploying the job, the scheduler 1 instructs the GW 14 to start waiting for a private network connection in response to a request from the helper container 6. The scheduler 1 starts the helper container 6 so that the helper container 6 requests a private network connection to the GW 14. When the private network connection is established, the GW 14 relays the communication between the user site storage 300 and the helper container 6 to establish a communication path. The helper container 6 starts the remote mount processing. When the execution of the job is completed, the configuration of the private network connection with the GW 14 is released. Note that the GW may cover a plurality of user sites.

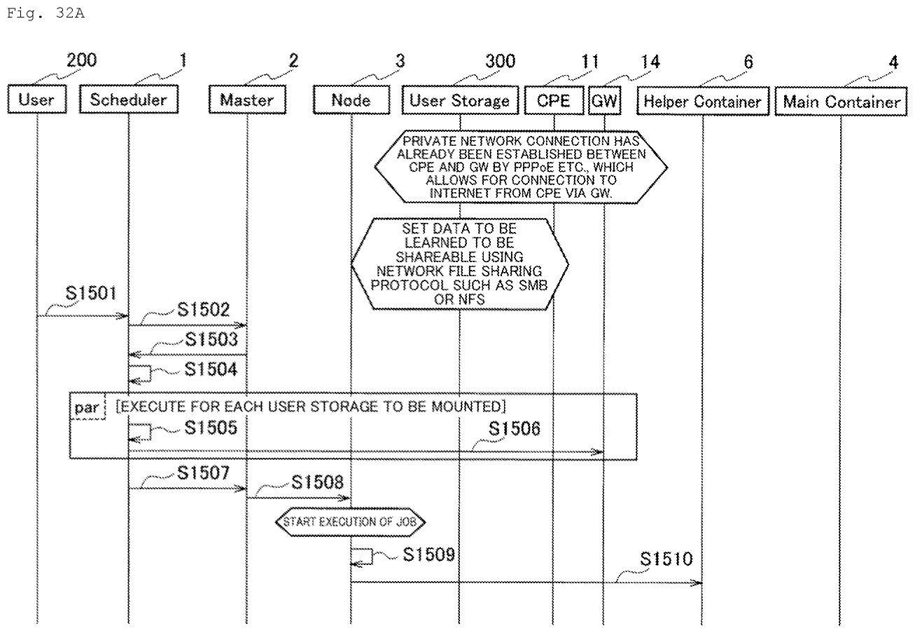

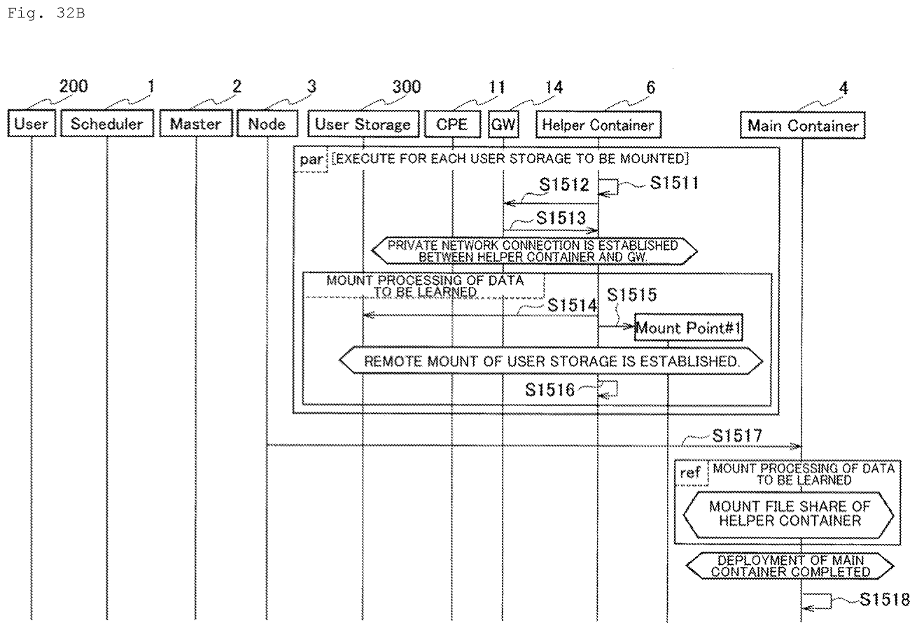

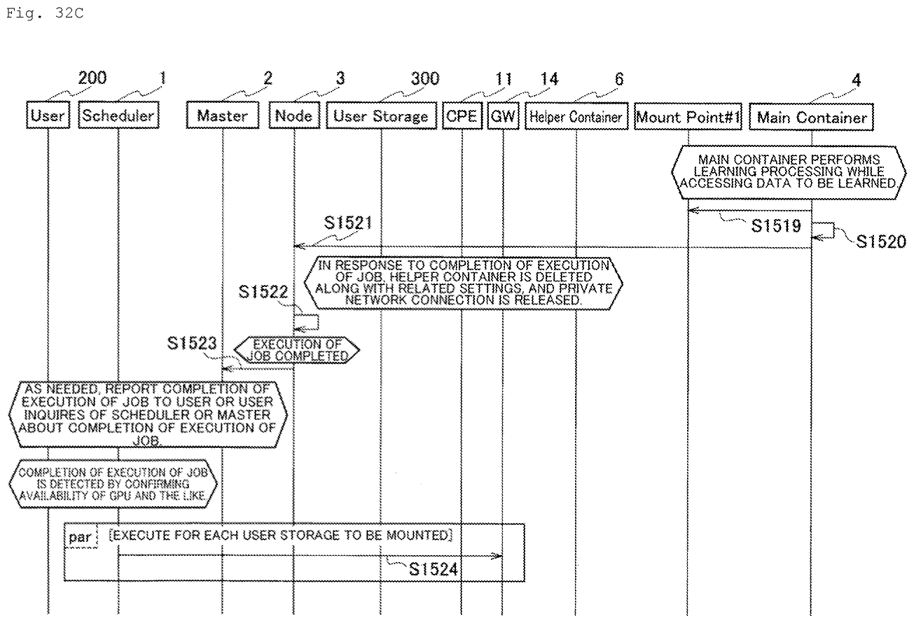

FIG. 32 is a diagram illustrating an operation sequence of the fifth private network connection method.

A private network connection has been established in advance between the CPE 11 and the GW 14 by PPPoE or the like, so that an internet connection can be made from the CPE 11 via the GW 14. Further, the user site storage 300 is set in advance so that the data to be learned can be shared by using the network file sharing protocol.

First, the user terminal 200 registers a job for a learning program to be executed in the scheduler 1 (step S1501). At this time, the user terminal 200 transmits definition information on the job, information on access to data to be learned (including the IP address set in the user site storage 300), line identification information, authentication information such as a user ID, and the like to the scheduler 1. After authentication processing or the like is completed between the user terminal 200 and the scheduler 1, it proceeds to the subsequent processing.

Next, the scheduler 1 inquires of the master 2 about the availability of GPU resources (step S1502), receives a report of the availability of GPU resources from the master 2 (step S1503), and then schedules the execution time for the job based on the report (step S1504).

Next, based on the line identification information, the scheduler 1 identifies the GW 14 to which the CPE 11 is connected (step S1505), and makes a setting for that GW 14 to wait for a private network connection with the helper container 6, and a setting for that GW 14 to relay the private network connection (step S1506). For example, in the setting for relaying the private network connection, the scheduler 1 establishes the private network connection with the helper container 6, relays the private network connection between the CPE 11 and the GW 14 and the private network connection between the GW 14 and the helper container 6 through routing, switching, and the like, and creates a logical private network path between the CPE 11 and the helper container 6. By using the private network path, the helper container 6 and the user site storage 300 following the CPE 11 can communicate with each other. In the GW 14, among traffic from the followers of the CPE 11, only the traffic to the helper container 6 is transferred to the private network path. It can be shared with the connection to the Internet from the followers of the CPE 11. At this time, based on the setting applied to the GW 14, the scheduler 1 makes a setting for a private network connection with the GW 14.

Next, the scheduler 1 instructs the master 2 to deploy the job (step S1507). At this time, the scheduler 1 transmits the definition information on the job, the information on private network connection to the GW 14, the information on access to data to be learned, the authentication information such as a user ID, and the like to the master 2.

Next, the master 2 deploys the job to the node 3 (step S1508). At this time, the master 2 transmits the definition information on the job, the information on private network connection to the GW 14, and the information on access to data to be learned to the node 3.

Next, based on the definition information on the job, the node 3 builds a virtual environment for the job (step S1509), and creates a helper container 6 (step S1510). At this time, the node 3 transmits the information on private network connection to the GW 14 and the information on access to data to be learned to the helper container 6.

Next, based on the information on private network connection to the GW 14, the helper container 6 makes a setting for a private network connection (step S1511), and requests the GW 14 for the private network connection (step S1512), and that GW 14 accepts the private network connection, accordingly (step S1513). As a result, the private network connection is established between the helper container 6 and the GW 14. The establishment of the private network connection between the helper container 6 and the GW 14 results in the establishment of the communication path for mounting the data to be learned in the user site storage 300 from the helper container 6. In other words, the private network connection between the helper container 6 and the GW 14 and the private network connection between the GW 14 and the CPE 11 serve as a communication path.

Next, based on the information on access to data to be learned, the helper container 6 mounts the data to be learned in the storage 300 by using the network file sharing protocol via the private network connection (step S1514). Further, the helper container 6 configures mount point #1 (step S1515). As a result, a remote mount of the storage 300 is established. After that, the helper container 6 sets mount point #1 to be in a transitive shared state (step S1516). Note that the mount processing of the data to be learned differs depending on the plurality of job configuration patterns described above. Here, a method is described in which the mount point of the storage 300 mounted in the helper container 6 is mounted also in a main container 4.

Next, the node 3 creates a main container 4 and mounts the file share of the helper container 6 (step S1517).

Next, the main container 4 starts the learning processing of the job (step S1518), performs the learning processing while accessing the data to be learned, and writes the learning processing results to mount point #1 (step S1519).

Next, after the learning processing is completed (step S1520), the main container 4 reports the completion of execution of the main container 4 to the node 3 (step S1521). In response to the completion of execution of the job, the helper container 6 is deleted along with related settings, and the private network connection with the vCPE 12 is released. Note that there are two methods for writing the learning processing results: a method of sequentially writing and a method of writing all at the end of the learning processing. The main container 4 may directly write the learning processing results to the user site storage 300 instead of mount point #1.

Next, the node 3 deletes the virtual space and the like for the job (step S1522), and reports the completion of execution of the job to the master 2 (step S1523). After that, as needed, the master 2 reports the completion of execution of the job to the user terminal 200. Alternatively, the user terminal 200 inquires the scheduler 1 or the master 2 about the completion of execution of the job. Further, the scheduler 1 detects the completion of execution of the job by confirming the availability of the GPU and the like.

Finally, the scheduler 1 instructs the GW 14 to delete the setting for waiting for a private network connection with the helper container 6 and the setting for relaying the private network connection (step S1524).

[Effects]

According to the present embodiments, the GPU learning cluster includes a helper container 6 that executes processing of making a private network connection to a user site storage 300 to mount the storage 300 inside a job, so that it is possible to provide a technique that can implement the private network connection to the storage of the user without making any changes to the virtual environment for the job for executing a learning program of the user and without modifying the core functions of OSS.

[Others]

In the drawings, “par” as used is an abbreviation for “parallel”. The processing in the frame of “par” (e.g., processing for each storage) is executed in parallel at the same time. The processing “par” may be changed to “loop” so that the processing in the frame of “loop” is sequentially executed. Also, “alt” is an abbreviation for “alternative”. One or more of a plurality of steps of processing in the frame of “alt” is selectively executed. Further, two or more of: the plurality of job configuration patterns and the plurality of private network connection methods, which are described above, may be combined.

The present invention is not limited to the above embodiments. The present invention can be modified in a number of ways within the spirit and scope of the present invention.

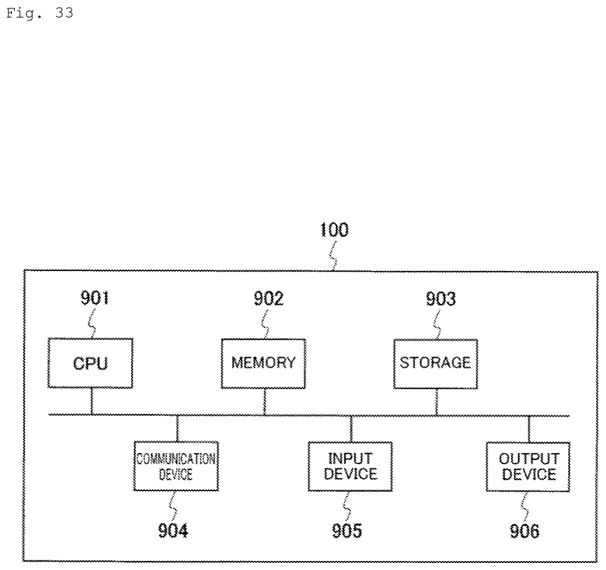

The information processing device 100 according to the present embodiments described above can be realized by using a general-purpose computer system including, for example, a CPU (Central Processing Unit, processor) 901, a memory 902, a storage 903 (HDD: Hard Disk Drive, SSD: Solid State Drive) 903, a communication device 904, an input device 905, and an output device 906, as illustrated in FIG. 33. The memory 902 and the storage 903 are storage devices. In that computer system, each function of the information processing device 100 is realized by the CPU 901 executing a predetermined program loaded on the memory 902.

The information processing device 100 may be implemented as one computer. The information processing device 100 may be implemented as a plurality of computers. The program for the information processing device 100 can be stored in a computer-readable recording medium such as an HDD, SSD, USB (Universal Serial Bus) memory, CD (Compact Disc), or DVD (Digital Versatile Disc). The program for the information processing device 100 can also be distributed via a communication network.

### REFERENCE SIGNS LIST

1 Scheduler
2 Master
3 Node
4 Main container
5 Cluster shared storage
6 Helper container
7 Remote mount storage
8 Container-to-container shared volume
9 Communication bridge
10 Volume
11 CPE
12 vCPE
13 ONU
14 GW
100 Information processing device

1. An information processing device comprising a Graphics Processing Unit (GPU) learning cluster, wherein
the GPU learning cluster includes
a first execution unit configured to execute a learning program of a job submitted by a user inside the job; and
a second execution unit configured to execute processing of making a private network connection to a storage of the user to mount the storage inside the job, and
the first execution unit is configured to read data to be learned from the mounted storage, and execute the learning program by using the data to be learned.

2. The information processing device according to claim 1, wherein
the first execution unit and the second execution unit belong to a same namespace, and
the second execution unit is configured to transfer, to the storage via a communication path of the private network connection, a communication that is from the first execution unit and that uses a network file sharing protocol addressed to a local host address allocated to a loopback interface in the namespace.

3. The information processing device according to claim 2, wherein
the first execution unit and the second execution unit belong to two namespaces communicatively connected to each other by a communication bridge, respectively, instead of the same namespace.

4. The information processing device according to claim 1, wherein
the GPU learning cluster further includes
a scheduling unit configured to schedule execution time for the job based on a usage of a GPU, and instruct at least one of a device which terminates a communication path of the private network connection on the user side and a device which terminates the communication path in a carrier network, to communicate over the private network connection.

5. The information processing device according to claim 1, wherein
the first execution unit and the second execution unit are built in a container that is a virtual environment.

6. An information processing method performed by an information processing device including a Graphics Processing Unit (GPU) learning cluster, the information processing method comprising:
executing, by the GPU learning cluster, a learning program of a job submitted by a user inside the job; and
executing, by the GPU learning cluster, processing of making a private network connection to a storage of the user to mount the storage inside the job,
wherein executing the learning program includes reading data to be learned from the mounted storage, and executing the learning program by using the data to be learned.

7. A non-transitory computer readable medium storing a program for causing an information processing device including a Graphics Processing Unit (GPU) learning cluster to:
execute, by the GPU learning cluster, a learning program of a job submitted by a user inside the job; and
execute, by the GPU learning cluster, processing of a private network connection to a storage of the user to mount the storage inside the job,
wherein executing the learning program includes reading data to be learned from the mounted storage, and executing the learning program by using the data to be learned.

8. The information processing device according to claim 2, wherein
the GPU learning cluster further includes
a scheduling unit configured to schedule execution time for the job based on a usage of a GPU, and instruct at least one of a device which terminates a communication path of the private network connection on the user side and a device which terminates the communication path in a carrier network, to communicate over the private network connection.

9. The information processing device according to claim 3, wherein
the GPU learning cluster further includes
a scheduling unit configured to schedule execution time for the job based on a usage of a GPU, and instruct at least one of a device which terminates a communication path of the private network connection on the user side and a device which terminates the communication path in a carrier network, to communicate over the private network connection.

10. The information processing device according to claim 2, wherein the first execution unit and the second execution unit are built in a container that is a virtual environment.

11. The information processing device according to claim 3, wherein the first execution unit and the second execution unit are built in a container that is a virtual environment.

12. The information processing device according to claim 4, wherein the first execution unit and the second execution unit are built in a container that is a virtual environment.
